(19) United States
(12) Patent Application Publication
(10) Pub. No.: US 2002/0033897 A1
(43) Pub. Date: Mar. 21, 2002

(54) Drive mounting system for an electronic device

(76) Inventors: Douglas Mayne, Ogden, UT (US); Carl F. Nicklos, Ogden, UT (US); Stephanie L. Seaman, Ogden, UT (US)

Correspondence Address: Michael K. Jones, WOODCOCK WASHBURN KURTZ, MACKIEWICZ & NORRIS LLP, One Liberty Place-46th Floor, Philadelphia, PA, 19103, US

(21) Appl. No.: 09/795,513

(22) Filed: Feb. 28, 2001

Related U.S. Application Data
(62) Division of application No. 09/663,179, filed on Sep. 15, 2000.

(51) Int. Cl. H04N 5/225

(52) U.S. Cl. 348/373

(57) ABSTRACT

A digital imaging device that utilizes a disk drive and a magnetic storage medium for transferring digital images. The device enables the user to transfer digital images from a flash card to a removable magnetic storage medium having high capacity. The device can also be used to view, edit or organize the digital images on a television, computer monitor or the like.

### FIELD OF THE INVENTION

The present invention relates in general to a digital imaging device, and particularly, to a digital imaging device for transferring and viewing digital images from a digital memory card to a removable disk having a high capacity data storage medium.

### BACKGROUND OF THE INVENTION

In recent years, conventional film cameras using a film medium to capture an image are being replaced in the market by digital cameras that capture an electronic image using an image sensor. The digital camera allows the electronic image to be stored in a digital memory card for later viewing or downloading.

Whether you use a digital camera for business or pleasure you need digital memory cards or “digital film” that perform seamlessly with your camera. There are many types of digital film on the market today. CompactFlash™ and SmartMedia™ (SSFDC) are two examples of popular digital film. Digital cameras also allow the user to view the digital images with the aid of a personal computer or some other microprocessor.

There are, however, several limitations to digital cameras and digital film. One limitation is that digital film has a limited capacity as compared to other forms of conventional data storage mediums, such as magnetic and optic mediums. Therefore, digital film cannot hold as many images as a device that would have a magnetic storage medium. Another limitation is that digital film is expensive relative to a magnetic storage medium.

Therefore, a need exists for a digital imaging device for transferring digital images from a digital memory card to a removable disk having a high capacity data storage medium. A need also exists for a digital imaging device that having a microprocessor that allows digital data, such as digital photographs to be viewed directly on a display device, such as, for example, a television set, without the use of an external computer device. In addition, a need exists for a digital imaging center for organizing, editing, and viewing digital images on an external display device, including a television set and/or a computer. A need also exists for a digital imaging device that can copy digital images from the lower capacity and more expensive digital film to a higher capacity and less expensive data storage medium. This would give the user more storage capacity because once the images are copied from the digital film to the magnetic medium, the digital film could be reused.

It is desirable to have a door that cover the slots for receiving removable components and data storage devices, but that also does not interfere with the insertion of the devices into the slots. Most digital cameras generally accept either a Type I or Type II digital film card. Typically, a separate slot is required for each of these devices.

Therefore, a need exists for a digital imaging device having a door that accepts both Type I or Type II digital film cards which would give users greater flexibility in purchasing digital film cards and also require fewer openings in the device.

Yet another limitation that exists for portable disk drives is the drive assembly mounting system. Typical drive assembly mounting systems use screws or some other type of fastener device to mount the drive assembly to the enclosure. Also, the disk assembly may shake or rattle when in motion which can cause failure during the read/write process.

Therefore, a need exists for a digital imaging device with a disk drive unit that provides a secure mounting system that does not rattle when used in a portable device.

Still yet another limitation is that most devices have an electrical eject button which requires power to eject the cartridge from the device. Therefore, when a device loses power, the cartridge is stuck inside the device.

Therefore, a need exists for a digital imaging device that has a no power button which enables the user to eject the cartridge from the device in the event that the device is powerless.

Another limitation exists during manufacturing of the digital imaging device, when the light pipe is installed it interferes with the assembly of other components and may obstructs other components within the housing, such as the main processing board.

Therefore, a need exists for a digital imaging device that provides for ease of assembly and that uses a new configuration for the light pipe that does not obstruct any other components with the housing.

The present invention satisfies these foregoing needs.

### SUMMARY OF THE INVENTION

This present invention is directed to a digital imaging device for transferring and storing digital images from a compact flash memory to a flexible magnetic medium. The invention also directed to a digital imaging center for organizing, editing, and viewing digital images on a viewing environment, including a television set, a computer, or the like.

In another embodiment within the scope of the present invention, a portable image processing unit is provided for copying digital data, such as photographs, from a digital memory card to a removable disk having a high capacity data storage medium. The device includes a housing having a disk drive mounted therein. A removable disk having a high capacity data storage medium for storing digital images is provided and is removably inserted in the disk drive. At least one socket is formed in the housing for receiving a plug of a removable digital memory for a device of the type used to acquire digital images, the at least one socket connecting the digital images to the disk drive for storage on the removable disk. In addition, the disk drive may have means for connecting read back images stored on the disk to a viewing environment.

According to another aspect of the invention, the image processing unit includes a main processing board having a microprocessor for controlling the transfer of digital images from the removable digital memory to the disk drive for storage on the disk.

According to another aspect of the invention, the device is a digital camera and the removable digital memory is a flash card memory.

According to another aspect of the invention, the high capacity disk has a storage capacity of about 100 MB. According to another aspect of the invention, the high capacity disk has a storage capacity of about 200 MB.

According to another aspect of the invention, the viewing environment includes a display device having a monitor and the image processing unit is connected directly to the monitor, and is not connected to an external device having a hard drive, such as a personal computer. The viewing environment can include a television set and/or a computer.

According to another aspect of the invention, the digital imaging device includes a compact flash door which includes guide ribs that are preferably located at the extreme ends of the door, in order to accommodate and be compliant with both Type I and Type II devices. The guide ribs act as a guide to contact the portion of the Type I device that is common with the Type II device. The width between the guide ribs is preferably maintained at a dimension larger than the maximum width dimension on the portion of the Type II device that differs from the Type I device. The height of the guide ribs is preferably equivalent to different in height between the Type I and Type II device as applied to the door when it is at the operated opening angle (which is not necessarily 90 degrees, and in the preferred embodiment is about 80 degrees).

In addition, the back side (e.g., non-visible side) of the door includes a plurality of ribs designed to butt up against the drive unit inside the digital imaging device, thereby forming a hard limit for the opening motion of the door.

This design and construction of the compact flash door provides the advantage that the compact flash door acts to guide a Type I Compact Flash device with hindering the insertion of a Type II Compact Flash form factor device. The design provides a special door design, therefore keeping the functionality of having a door to cover the front opening of the digital imaging device.

According to another aspect of the invention, the digital imaging device includes an improved mounting system for mounting the drive assembly in the device. The improved mounting system includes a plurality of support members with horizontal and vertical side supports that are formed as part of the base to act as a platform or support member for the disk drive unit to sit on. The dimension of these support members is preferably ample to accommodate the range in tolerances of expected drive assemblies. At this point the drive is allowed to “rattle.”

The improved mounting system includes a plurality of long retention members having hooks at their distal ends and which extend from the base unit extending to a height that allows these hooks to latch over the top edge of the drive assembly. Preferably, the retention members are positioned at an angle that caused the retention members and hooks to only be in contact at the upper most portion of the drive lip. The angle cause a situation of clearance between the retention members and drive that existed at a minimum at the top of the drive where the hook contacts, to a maximum where retention members extended below the drive unit. At this point, with all components assembled (minus cover attachment), the drive unit is secured sufficiently to allow the subassembly to be transported, turned over, or tested without the danger of the drive falling out of the subsystem and getting damaged.

To enhance the retention members, a plurality of reinforcing members (e.g., vertical ribs of substantial structure) are incorporated into the cover. The position of the reinforcing members is directly above and slightly outside the form factor of the drive assembly. The purpose of these reinforcing members is to engage, with an interference fit, the retention members mention above. The point of contact is at a location below the contact point of the drive hooks with the drive assembly. The purpose of these reinforcing members is to act as a backup structure to the drive hooks, preventing the drive mounting hooks and retention members from becoming disengaged from the top comer of the drive assembly. This allows the drive mount hooks and retention members to take the load of the drive assembly during drop-shock testing. Designing the reinforcing members to be an interference fit promoted the hooks to apply a later force to the drive assembly, and therefore removing the clearance/slop designed into the system to allow for various size drive assembly units.

According to another aspect of the invention, the digital imaging device includes an improved light pipe. The improved light pipe includes a light pipe that snaps into place, can be assembled after the PCA that it is positioned above is installed, is removable to allow for rework should the PCA need to be removed, can withstand the shock requirement of the product, and does not introduce any additional side actions or undercuts to the base enclosure that the light pipe is attached to. The light pipe of the present invention includes a hook feature designed onto the light pipe. This hook feature furthermore was dropped into a pocket that was molding into an edge wall on the base enclosure plastics. Once the hook on the light pipe was installed into the pocket, the light is rotated into position, allows a cylindrical feature (that light passes through) to pass through a cylindrical hole through the front of the base unit. An interference was designed in, such that the distance from bottom of pocket in the base edge to the closest edge of the cylindrical hole was greater than the distance from the hook tip that contact the bottom of the pocket and the closest edge of the cylindrical section of the light pipe that passed through the base hole. The snapping action of the light pipe as it is assembled is enhanced by the fact the light pipe has to fit around the hypotenuse of the triangle formed from pocket, to a point on the cylindrical hole perpendicular to the pocket, to a point where the cylindrical hole breaks through the interior surface of the base.

According to another aspect of the invention, the digital imaging device includes an improved no power eject button. The no power button allows a user to remove a disk from the drive even when no power is available by providing a design that incorporates an extended no power eject button and guide mechanism from the rear panel forward to, and inside, the hole provided in the back of the disk drive for ejecting the disk cartridge with a pin portion of the no power eject button. The no power button includes a plunger, preferably designed and molded from an inexpensive plastic material, or the like. The design incorporated one end similar in size to a paper clip, and at the other end design substantial in size to allow for the use of either a pen, pencil, or typical keys to be use to activate the device. The rear most portion, or head, was design as to utilize a piston in a cylinder type configuration therefore allowing the user to activate the mechanism with common found items and ejecting the cartridge from the unit. A spring surrounds the narrow pin portion and biases the plunger toward the rear of the unit.

Assembly of the no power eject device is accomplished through installing the spring over the narrow pin portion of the plunger and then inserting the narrow end of the plunger through the rear opening on the drive. Once compressed sufficiently, the large end or head of the plunger can be inserted into the cylinder portion of the tunnel mechanism located in the rear panel. Accidental over travel is prevented by the addition of a guide member having a slotted wall that protrudes and extends from the cover. Once installed the slotted wall prevents the plunger from being activated beyond its intended travel.

The foregoing and other aspects of the present invention will become apparent from the following detailed description of the invention when considered in conjunction with the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific methods and instrumentalities disclosed. In the drawings:

FIG. 1A is a front perspective view of an exemplary digital imaging device according to the present invention;

FIG. 1B is a rear perspective view of the digital imaging device of FIG. 1A;

FIG. 2A is a front perspective view of the digital imaging device of FIG. 1A with the cover removed for clarity;

FIG. 2B is a rear perspective view of the digital imaging device of FIG. 1B with the cover removed for clarity;

FIG. 3 shows the digital imaging device of FIG. 2A with the disk drive removed for clarity;

FIG. 4A is top perspective view of an exemplary cover of the digital imaging device of FIG. 1A;

FIG. 4B is bottom perspective view of the cover of the digital imaging device of FIG. 1A;

FIG. 4C is a plan view of the inside of the cover of FIG. 4A;

FIG. 4D is a cross sectional view of the cover of FIG. 4C taken along sectional line 4D-4D;

FIG. 4E is a cross sectional view of the cover of FIG. 4C taken along sectional line 4E-4E;

FIG. 5A is a top view of an exemplary inlay of the cover of FIG. 4A;

FIG. 5B is a side view of the inlay of the cover of FIG. 5A;

FIG. 5C is a front view of the inlay of the cover of FIG. 5A;

FIG. 5D is a cross sectional view of the inlay of the cover of FIG. 5A taken along sectional line 5D-5D;

FIG. 6A is a top perspective view of an exemplary base from the front of the digital imaging device of FIG. 1A;

FIG. 6B is a top perspective view of the base from the rear of the digital imaging device of FIG. 1B;

FIG. 6C is a bottom perspective view of the base from the front of the digital imaging device of FIG. 6A;

FIG. 6D is a detail view of one of the feet on the base of FIG. 6C;

FIG. 6E is a plan view of the inside of the base of FIG. 6A;

FIG. 6F is a side view of the base of FIG. 6E;

FIG. 6G is a cross sectional view of the base of FIG. 6E taken along sectional line 6G-6G;

FIG. 6H is a cross sectional view of the base of FIG. 6E taken along sectional line 6H-6H;

FIG. 6I is a detail view of detail 61 of FIG. 6E;

FIG. 6J is a detail view of detail 6J of FIG. 6E;

FIG. 6K is a cross sectional view of FIG. 6A;

FIGS. 6L and 6M show the interaction between the retention members and the reinforcing members;

FIG. 7A is a plan view of an exemplary rear panel of the digital imaging device of FIG. 1A;

FIG. 7B is a rear perspective view of the rear panel of FIG. 7A;

FIG. 7C is a top view of the rear panel of FIG. 7A;

FIG. 7D is a cross sectional view of the rear panel of FIG. 7C taken along sectional line 7D-7D;

FIG. 8 is a perspective view showing the location of an exemplary no power eject button in accordance with the present invention;

FIG. 9A is a front perspective view of the no power ejection button of FIG. 8;

FIG. 9B is a rear perspective view of the no power ejection button of FIG. 9A;

FIG. 9C is a side view of the no power ejection button of FIG. 9A;

FIGS. 9D-9F show the no power ejection button of FIG. 9A in the non-operating or non-depressed state;

FIGS. 9G-9I show the no power ejection button of FIG. 9A in the operating or depressed state;

FIG. 10A is a perspective view showing the front of an exemplary compact flash door of the digital imaging device of FIG. 1A;

FIG. 10B is a perspective view showing the rear of the compact flash door of FIG. 10A;

FIG. 10C is a plan view of the back of the compact flash door of FIG. 10B;

FIG. 10D is a plan view of the top of the compact flash door of FIG. 10A;

FIG. 10E is a side view of the compact flash door of FIG. 10D;

FIGS. 10F, 10G, 10H, and 10I show the operation of the compact flash door for both Type I and Type 11 compact flash compliant devices;

FIG. 11 is a perspective view showing the location of an exemplary copy button and the power light pipe in accordance with the present invention;

FIG. 12A is a front perspective view of an exemplary copy button of the digital imaging device of FIG. 11;

FIG. 12B is a rear perspective view of the copy button of FIG. 12A;

FIG. 12C is a side view of the copy button of FIG. 12A;

FIG. 12D is a rear view of the copy button of FIG. 12A;

FIG. 13A is a perspective view of an exemplary power light pipe of the digital imaging device of FIG. 11;

FIG. 13B is a top view of the power light pipe of FIG. 13A;

FIG. 13C is a front view of the power light pipe of FIG. 13A;

FIG. 13D is a side view of the power light pipe of FIG. 13A;

FIGS. 13E-13F show the light pipe being rotated into the base;

FIGS. 13G-13I show the light pipe installed in the base;

FIG. 14A is a perspective view from the front of an exemplary drive ejection button of the digital imaging device of FIG. 1A;

FIG. 14B is a perspective view from the rear of an exemplary drive ejection button of the digital imaging device of FIG. 14A;

FIG. 14C is a front view of the drive ejection button of FIG. 14A;

FIG. 14D is a cross sectional view of the drive ejection button of FIG. 14C taken along sectional line 14D-14D;

FIG. 14E is a cross sectional view of the drive ejection button of FIG. 14C taken along sectional line 14E-14E;

FIGS. 15A and 15B are flow diagrams showing an exemplary process for connecting the digital imaging device to a display device in accordance with the present invention;

FIG. 16 is flow diagram showing an exemplary process for copying and viewing digital images using the digital image device without using a computer in accordance with the present invention;

FIGS. 17A, 17B, and 17C are flow diagrams showing several alternative processes for copying digital images for viewing; and

FIG. 18 shows an exemplary remote device that can be used with the digital imaging device.

### DESCRIPTION OF EXEMPLARY EMBODIMENTS AND BEST MODE

The present invention is directed to a digital imaging device that can be used to transfer digital photos from a digital memory card or “digital film” (e.g., Smart Media and Compact Flash cards) to a removable disk having a high capacity data storage medium. The digital imaging device can transfer digital images independently of an external computer and without being connected to a viewing environment, such as a television set (TV) or a computer. The present invention also allows the digital imaging device to be used in a viewing environment having a display device, including, for example, with a TV, a computer monitor, a LCD, or the like.

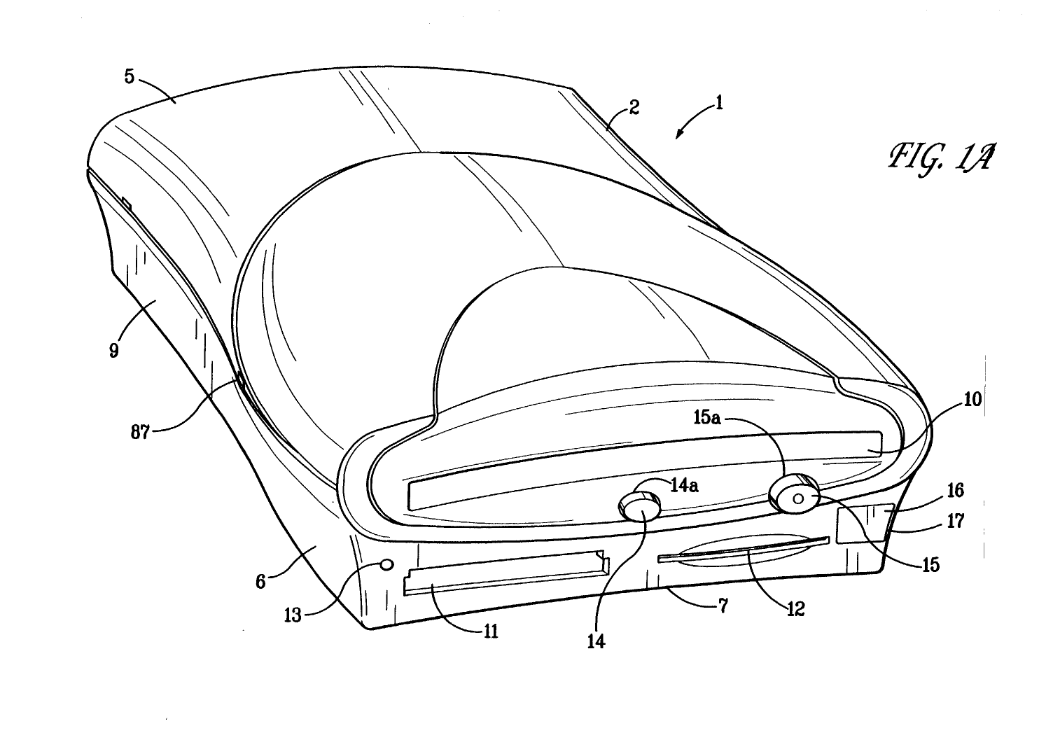

This invention is directed to a digital imaging device 1, as shown in FIGS. 1A-14E, for transferring digital data from “digital film” to a removable disk having a high capacity data storage medium. As alluded to above, the digital imaging device 1 may also be used for organizing, editing, and viewing digital data, such as for example photographs. The removable, high capacity disk that may be used with the present invention includes a variety of types of data storage media, such as magnetic media and optical media. An exemplary removable data storage cartridge that has a high capacity data storage medium is shown in commonly assigned U.S. Pat. No. 5,650,891 entitled “Apparatus For Performing Multiple Functions In A Data Storage Device Using A Single Electro-Mechanical Device,” which is hereby incorporated by reference. Even more specifically, the high capacity data storage medium may be flexible or rigid, magnetic or optical, etc. For example, the invention may be used with a flexible magnetic media, such as the Zip® disk cartridge or the like.

FIGS. 1A and 1B show an exemplary digital imaging device 1 having a housing 2 for holding a disk drive 30 and a main processing board 35 having control circuitry and interface connections for transferring digital image data from a “digital film” (e.g., solid state memory or digital memory card) to the high capacity removable data storage medium and for viewing the digital image data in a viewing environment having a display device (not shown). FIG. 1A shows a front perspective view and FIG. 1B shows a rear perspective view of the digital imaging device housing 2 including a cover 5, a base 6, a front panel 7, a rear panel 8, and two side walls 9.

As shown in FIG. 1A, the front panel 7 includes a plurality of control buttons and indicators, as well as a plurality of slots for receiving various types of “digital film” and also a slot for receiving the removable, high capacity data storage disk. A data storage disk slot 10 is provided in the front panel 7 for receiving a data storage disk, such as, for example, a Zip® cartridge or the like. A compact flash form factor slot 11 is provided in the front panel 7 for receiving a compact flash compliant device (Type I or Type II), such as, for example, a CompactFlash™, or the like. A smart media form factor slot 12 is provided in the front panel 7 for receiving a smart media compliant device, such as, for example, a SmartMedia™ card, or the like. A power light indicator 13 is provided for indicating when power is available to the digital imaging device 1. A copy button 14 is provided for initiating the copying of digital data between one of the types of “digital films” and the removable, high capacity data storage medium. A disk eject button 15 allows for the ejection of a data storage disk from the disk drive 30. A sensor 16 is provided for use with a remote 400 for remote operation of the digital imaging device 1. Preferably, a window 17 is provided in the front panel 7 for the sensor 16. Preferably, the sensor 16 is an infrared sensor. Although not shown, the digital imaging device can also include a PCMCIA form factor slot for receiving a PCMCIA compliant device.

As shown in FIG. 1B, the rear panel 8 includes a plurality of controls and interface connectors. A power connector 20 is provided for connection to a power cord to supply electrical power to the digital imaging device 1. An USB connector 21 is provided for use in connecting the digital imaging device 1 to a computer. The USB port 21 need only be used when connecting the digital imaging device 1 to a computer, and is not necessary to connect other display or viewing devices to the digital imaging device. A S-Video (S-VHS) connector 22 and a Composite (RCA) Video Out connector 23 are provided on the rear panel 8. A no power (e.g., emergency) disk eject button 24 is provided for ejecting a disk when power has been lost. Preferably, the emergency disk eject button 24 is recessed, or otherwise covered, to prevent again inadvertent activation of this feature. A left (Mono) audio channel out connector 25 and a right audio channel out connector 26 are also provided on the rear panel 8, as shown in FIG. 1B.

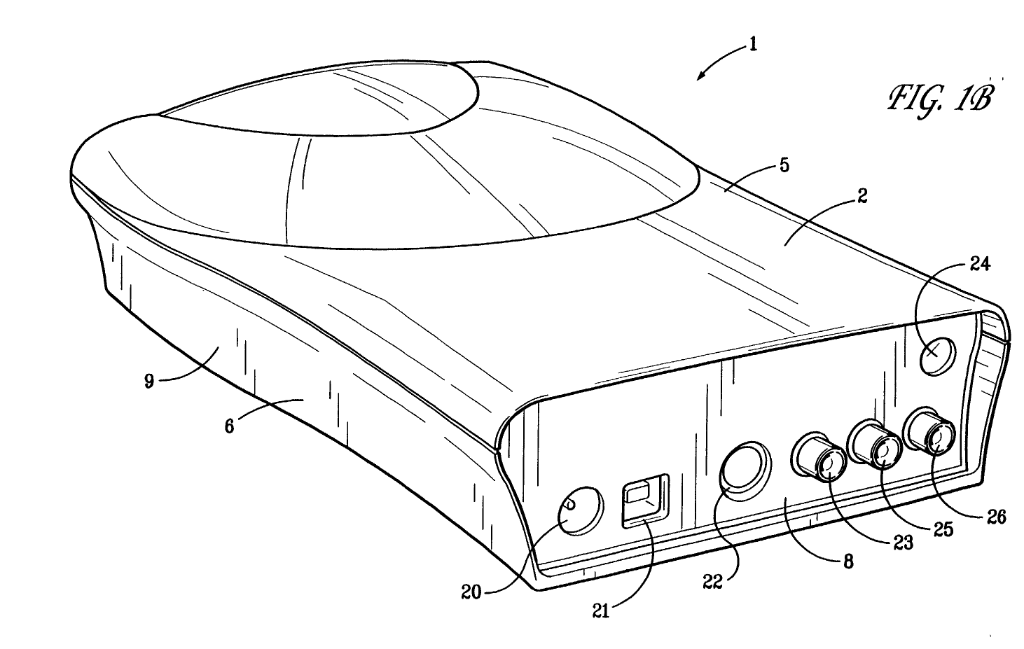

FIGS. 2A and 2B show front and rear perspective views of the digital imaging device 1 of FIG. 1A and 1B, respectively, with the cover 5 removed for clarity. As shown in FIGS. 2A and 2B, the digital imaging device 1 includes a disk drive 30 for receiving a removable, high capacity data storage disk in disk drive opening 31. The disk drive 30 is used to communicate digital data, including photographs (e.g., digital images), between the “digital film” or digital memory card and the removable, high capacity data storage medium. The disk drive 30 provides electrical communications to transfer digital data to a relatively high density data storage medium, such as the Zip® 100 disk cartridge, Zip® 250 disk cartridge, or other high capacity, removable data storage mediums. For example, the magnetic head assembly of this invention may be employed with the disk drive described in U.S. Pat. No. 5,650,891, which is hereby incorporated by reference.

The disk drive has a head assembly (not shown) that provides electrical communication with the high capacity, removable data storage medium. The head assembly may include a magnetic head assembly that is employed with flexible magnetic storage media, or the head assembly can be employed with other types of media, such as optical media.

By way of background, the disk drive has a disk drive motor for operating the disk cartridge, such as, but not limited to, the one shown in U.S. Pat. No. 5,650,891. In this type of disk drive, the disk drive motor is a spindle motor that is disposed in the chassis of the disk drive. When the disk cartridge is inserted into the disk drive, the disk drive motor engages the hub of the disk or disk cartridge. When engaged with the hub of the disk cartridge, the disk drive motor is operated by a microprocessor to rotate the hub and the attached high capacity removable data storage medium.

Neither the disk drive nor the data storage disk described above are part of this invention. However, they may be used in combination with the digital imaging device 1 of this invention, which is described in detail below.

The head assembly may be disposed on an actuator within the disk drive. The actuator may be a linear type of actuator as disclosed in U.S. Pat. No. 5,650,891. Alternatively, the actuator may be a rotary type of actuator, as shown in commonly assigned U.S. Pat. No. 5,636,085, entitled “Magnetic Read/Write Head Assembly Configuration With Bleed Slots Passing Through Rails to Stabilize Flexible Medium While Attaining Low Fly Heights With Respect Thereto,” which is hereby incorporated by reference.

The head assembly of this invention may include a first slider and a second slider. When the actuator is in the interfacing position, described more fully below, the high capacity removable data storage medium may be disposed between the first and the second slider. In this position, the first slider may be disposed proximal to a first surface of the storage medium, and the second slider may be disposed proximal to a second surface of the storage medium. The first slider is disposed above the storage media and the second slider is disposed beneath the storage media. However, the invention is not so limited. The first slider and the second slider are disposed on opposing sides of the media and they may not be disposed above and below each other depending upon the orientation of the media.

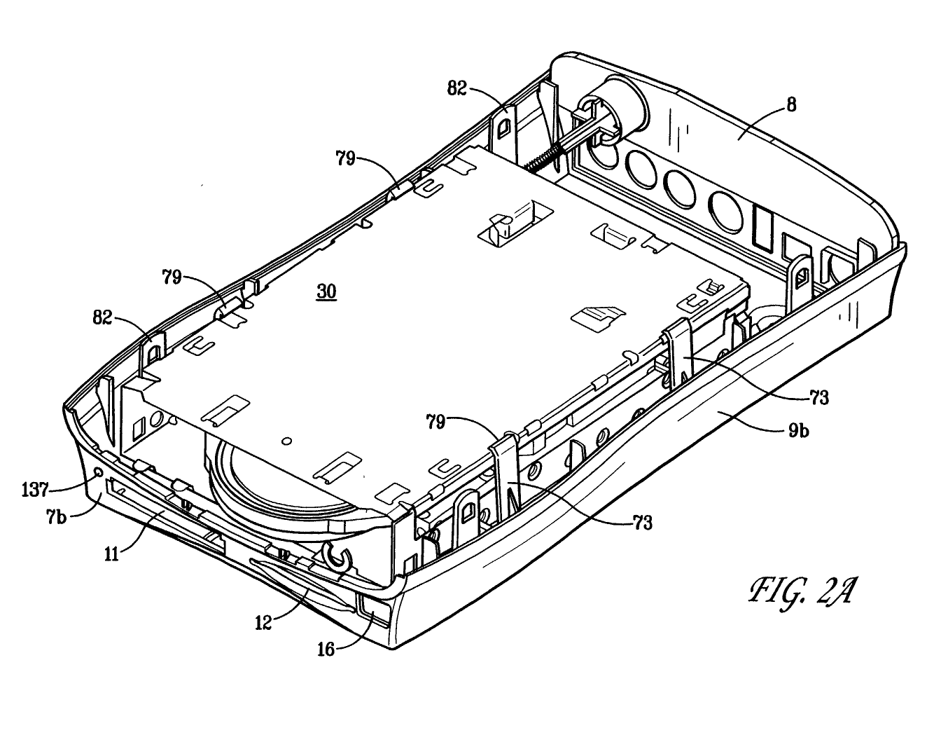

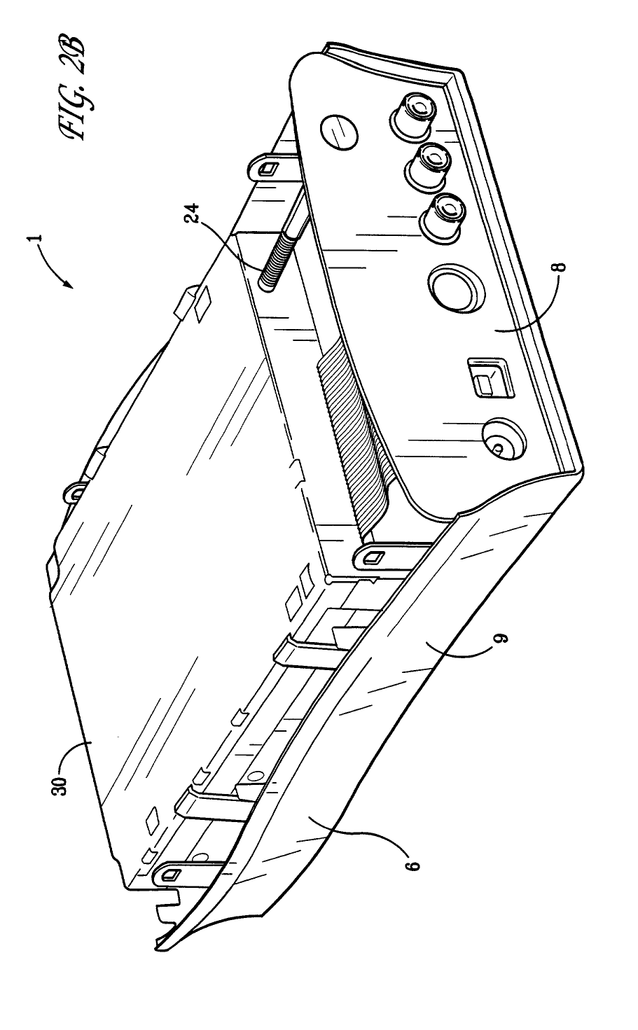

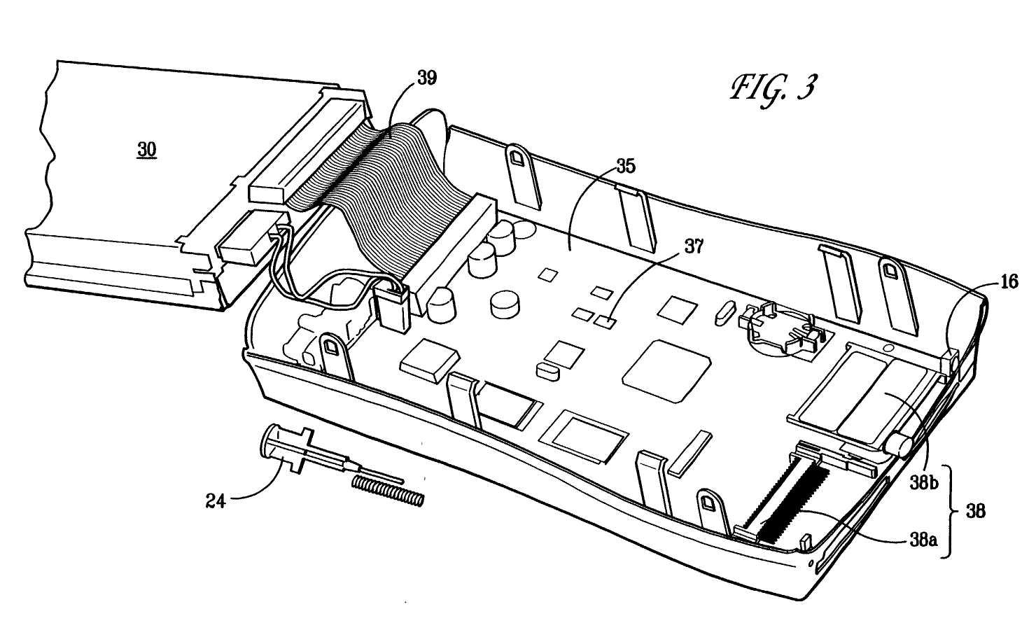

FIG. 3 shows the digital imaging device 1 of FIG. 2A with the disk drive 30 removed for clarity. As shown in FIG. 3, the digital imaging device 1 includes a main processing board 35. The main processing board 35 includes a micro-processor 36, integrated circuitry 37, a plurality of electrical sockets 38, the IR sensor 16 for controlling the device using a remote, power functions, interface controls, etc. The main processing board 35 functions to control various functions of the digital imaging device 1, including transferring of digital data from different types of “digital film” to a high capacity removable data storage medium, as well as, organizing, editing, presenting, and viewing digital data (e.g., photos). The main processing board 35 includes the control circuitry 37 and is connected to each of the plurality of controls buttons, indicators, as described above and shown in FIG. 1A. A plurality of sockets 38 for receiving various types of “digital film” are located on the main processing board 35, including a compact flash form factor socket 38a for communicating with a compact flash compliant device (Type I or Type II), and a smart media form factor socket 38b for communicating with a smart media compliant device. A flex circuit 39 connects the disk drive 30 and the main processing board 35. The main processing board also includes the control circuitry and interfaces for the plurality of controls and interface connectors included on the back panel, as described above and shown in FIG. 1B.

FIGS. 4A through 4E show an exemplary cover 5 of the digital imaging device 1. FIGS. 4A and 4B are top and rear perspective view, respectively, of the cover 5. As shown in FIGS. 4A and 4B, the cover 5 includes a main cover body 40, a top surface 41, two partial side walls 9a, a partial front panel 7a, and an inlay 42. A plurality of apertures 43 are formed in the top surface 41 of the main cover body 40 to provide access to the interior of the housing 2 and help facilitate manufacturing and assembly of the cover 5. When assembled, the inlay 42 connects to the main cover body 40 and covers the apertures 43 of the cover 5 and also helps to seal a portion of the front panel 7. Preferably, the main cover body is formed having a recessed surface 41a for receiving the inlay 42, as best shown in FIG. 4D. Preferably, the recessed surface 41a corresponds to the inlay 42.

FIG. 4C shows a plan view of the inside of the cover 5. As shown in FIG. 4C, the cover 5 includes a plurality of reinforcing members 44, a plurality of side positioning members 45, a plurality of end positioning members 46, a guide member 47, a plurality of alignment members 48, and a plurality of latches 49. As shown, the plurality of reinforcing members 44 extend downward from the cover 5 toward the base 6 and correspond to a plurality of retention members for holding the disk drive 30 in the housing 2. The plurality of reinforcing members 44 are positioned against an upper portion of each of the retention members and are adapted to prevent the retention members from flexing outwardly toward the sides 9 of housing 2, thereby positively restraining the disk drive 30 in place in the housing 2 and preventing the disk drive 30 from becoming free in the housing 2.

As shown in FIGS. 4C and 4D, the plurality of side positioning members 45 and the plurality of end positioning members 46 extend downward from the cover 5 toward the base 6 and help to locate and hold the disk drive 30 in the housing 2 and also help to strengthen the cover 5. The guide member 47 extends downward from the cover 5 toward the base 6 and preferably has an U-shaped body having two guides. The guide member 47 helps to position and guide the piston of the no power eject button and also acts as a stop by contacting a ledge on the no power eject button thereby stopping the inward movement (e.g., toward the disk drive 30) of the no power eject button.

The plurality of alignment members 48 are disposed between the cover 5 and the base 6 and include a plurality of alignment slots 50 and a corresponding plurality of alignment tabs 51 to help align the cover 5 and the base 6 with respect to one another during assembly and also to help hold the cover 5 and the base 6 together. As shown, the plurality of alignment slots 50 are formed on the cover 5 and include two raised ribs 52 that extend downward from the cover 5 and inward from the side walls 9a thereby defining a slot 53 therebetween. The plurality of latches 49 forms part of a snap mechanism that mechanically connects together the cover 5 and the base 6. FIG. 4D is a cross sectional view of the cover 5 of FIG. 4C and further shows the above features of the cover 5.

FIG. 4E is a cross sectional view of the cover 5 of FIG. 4C showing the partial front panel 7a, the disk slot 10 for receiving the removable, high capacity data storage disk, and a disk door for closing the disk slot 10 when the disk drive 30 is not in use. As shown, the cover 5 includes a portion 7a of the front panel 7. However, this is not required, and the front panel 7 could be formed separate and then connected to the cover 5. The disk door includes a hinge mechanism for allowing the disk door to rotate back and up thereby providing access to the disk drive 30 for the insertion of a high capacity data storage disk into disk drive opening 31. The disk door also includes a spring that is coiled as the disk door opens and acts to return the disk door to the closed position when the data storage disk is removed.

As shown in FIG. 4E, the partial front panel 7a of the cover 5 also can include an opening 14a for allowing the copy button 14 and an opening 15a for the disk eject button 15 to be extended through the front panel 7 and be accessed by a user. Two openings 54 are formed in the top surface 41 of the cover 5, preferably one above each end of the disk door proximate the location of the hinge mechanism of the disk door, to facilitate assembly of the disk door. When assembled, the inlay 42 covers openings 54.

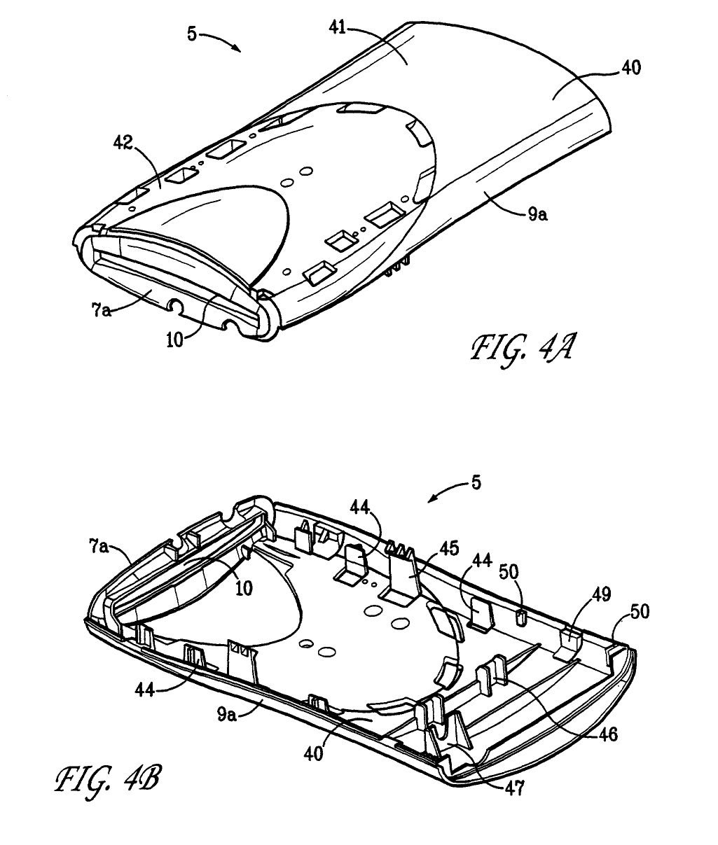

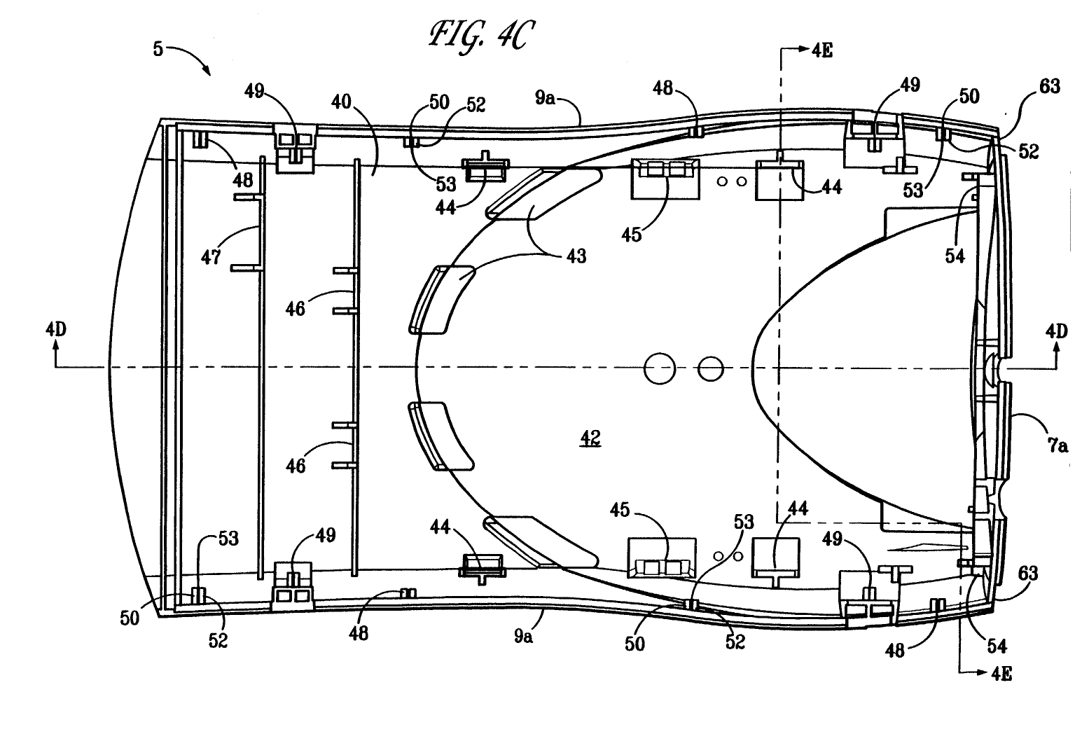

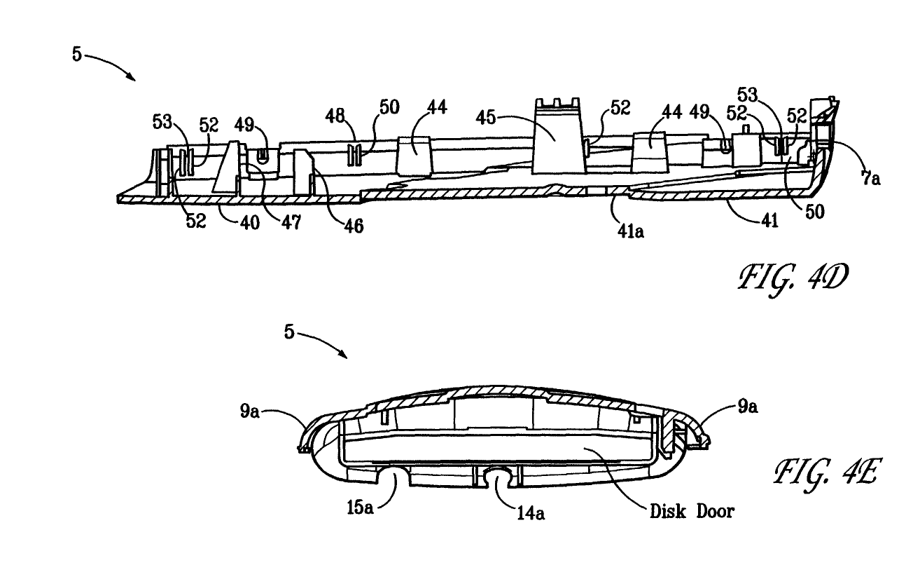

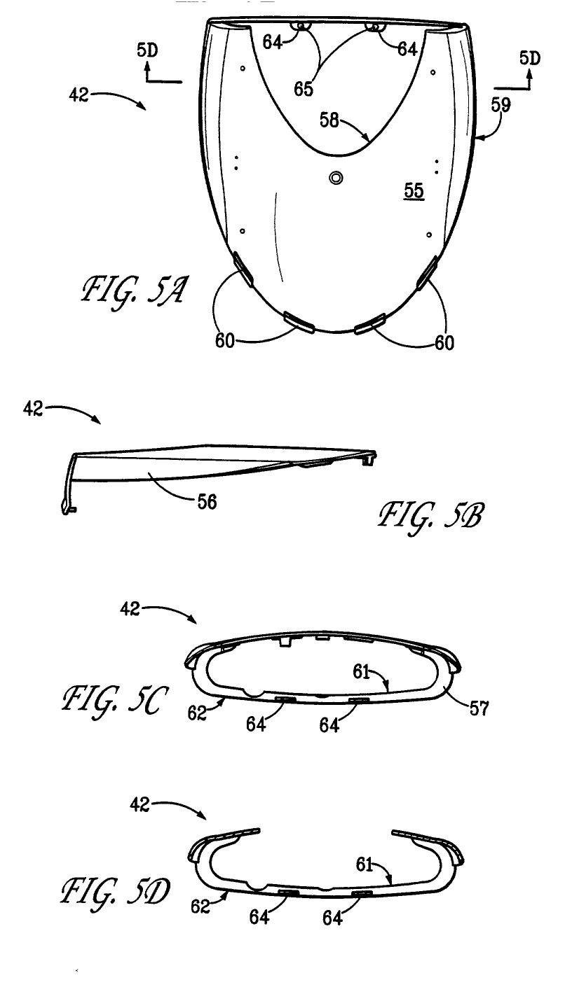

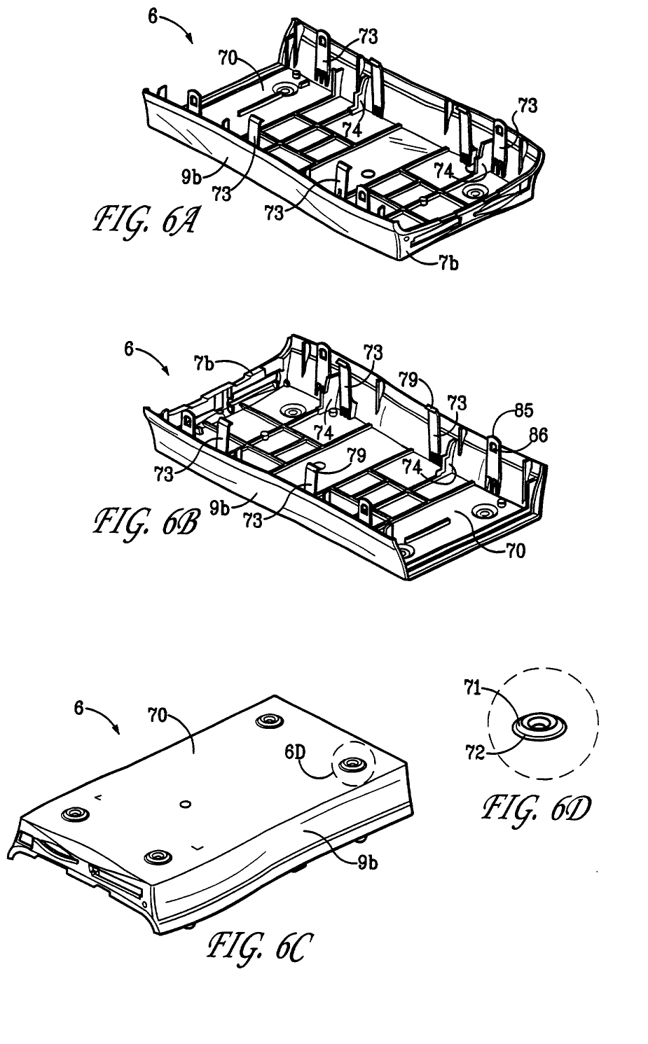

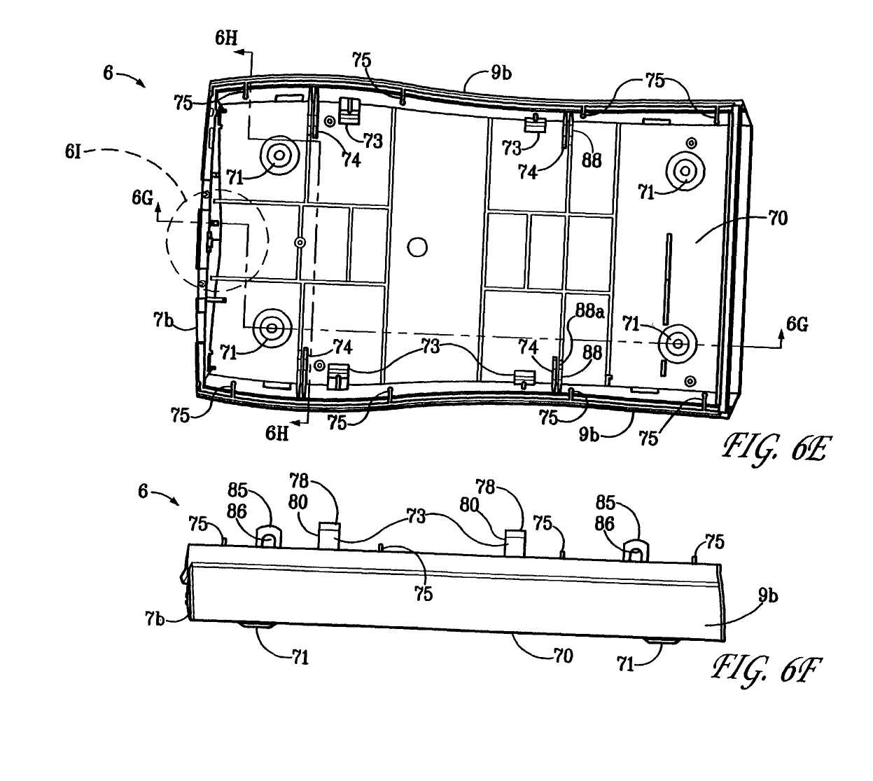

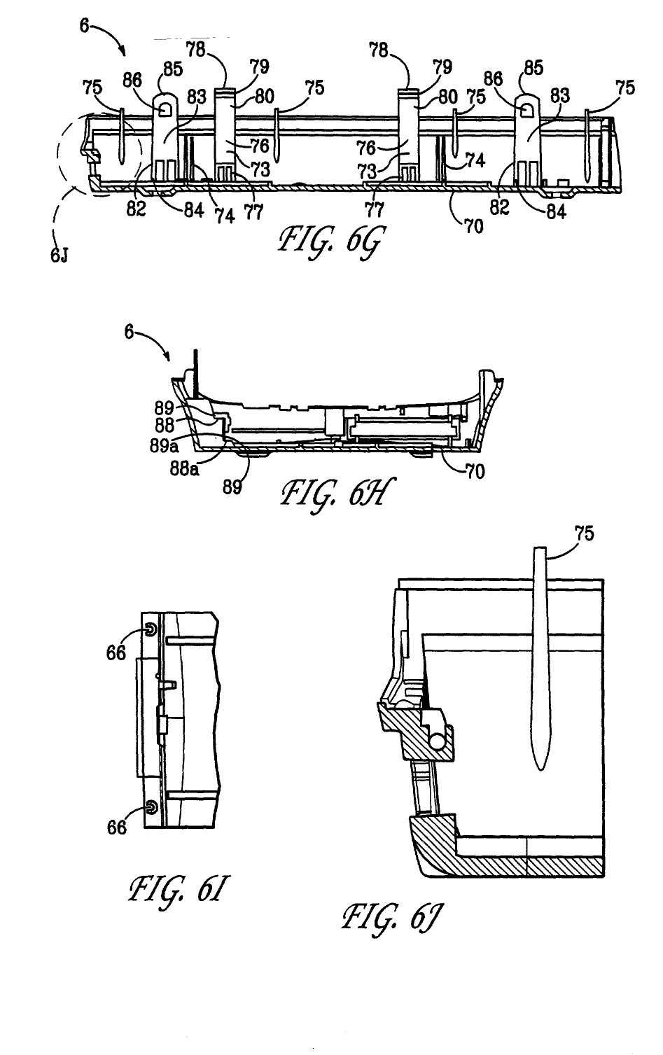

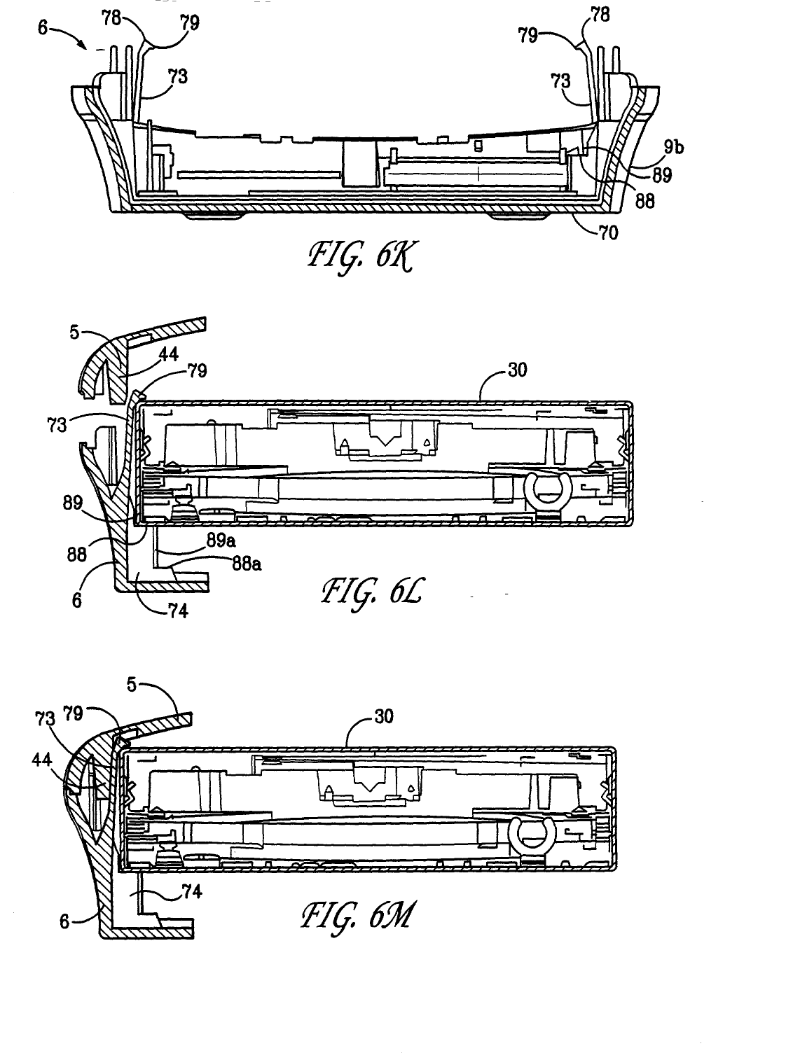

FIGS. 5A through 5D show an exemplary inlay 42. As shown in FIGS. 5A through 5D, the inlay forms part of the cover 5, part of the front panel 7, and part of the side walls 9 of the housing 2. As shown, the inlay 42 can be formed having a crescent-shaped portion 55, as viewed from the top in FIG. 5A, a tapered portion 56, as viewed from the side in 5B, and an elliptical-shape curved portion 57, as viewed from the front in FIG. 5C. The crescent-shaped portion 55 has an inner edge 58 and an outer edge 59. Preferably, a main cover body 40 of the cover 5 is formed with a recessed surface 41 a corresponding in shape and thickness to the shape and thickness of the inlay 42. A plurality of tabs 60 can be formed extending from the outer edge 59 of the crescent-shaped portion 55 toward the rear panel 8 of the housing 2 to facilitate connection of the inlay 42 to the main cover body 40. As shown, the crescent-shaped portion 55 of the inlay 42 includes four tabs 60 that fit into and engage corresponding apertures 43 formed in the main cover body 40. The elliptical-shape curved portion 57 has an inner edge 61 and an outer edge 62. Preferably, the front panel 7 is formed with a recessed surface 63 corresponding shape and thickness to the shape and thickness of the elliptical-shape curved portion 57 of the inlay 42. A plurality of tabs 64 can be formed extending from the elliptical-shape curved portion 57 toward the rear panel 8 to facilitate connection of the inlay 42 to the front panel 7. As shown, the elliptical-shape curved portion 57 of the inlay 42 includes two tabs 64 having an aperture 65 formed in a center region of each tab 64. The aperture 65 of the tabs 64 fit over and engage corresponding posts 66 extending upward from the lower portion of the front panel 7 (see FIG. 6I). Preferably, the elliptical-shape curved portion 57 is flexible relative to the crescent-shaped portion 55 to facilitate fitting of the inlay 42 over the main cover body 40 and the partial front panel 7a. The inlay 42 functions to cover up the various apertures 43 and openings 54 in the main body cover 40 and the front panel 7 that facilitate manufacturing and assembly of the digital imaging device 1.

FIG. 6A through 6J show an exemplary base 6 of the digital imaging device 1. FIGS. 6A and 6B show a front perspective and a rear perspective view of the digital imaging device 1, respectively. As shown in FIGS. 6A and 6B, the base 6 includes a bottom surface 60, two partial side walls 9b, and a partial front panel 7b.

FIG. 6C shows the bottom surface 60 of the base 6 including a plurality of feet 71 for supporting the digital imaging device 1. As shown the base 6 includes four feet 71. The feet 71 may be attached to the base 6 use conventional techniques, such as fasteners (not shown). The base 6 may include openings that a fastener, such as for example, a screw may pass through to connect each foot 71 to the base 6. Preferably, the feet 71 are made of a material having a high friction characteristics, such as a rubber material, to prevent sliding of the digital imaging device 1 over a surface. FIG. 6D is a detail view of one of the feet 71 on the base 6 of FIG. 6C.

FIG. 6E is a plan view of the inside of the base 6. As shown in FIG. 6E, the base 6 includes a plurality of retention members 73,a plurality of support members 74, and a plurality of alignment tabs 75 which form part of the plurality of alignment members 48. As shown, the plurality of retention members 73 extend upward from the base 6 toward the cover 5 and correspond to a plurality of reinforcing members 44 extending downward from the cover 5 for holding the disk drive 30 in the housing 2. Each retention members 73 includes a body 76 having a fixed end 77 connected to the base 6 and a free or distal end 78. A hook 79 is formed at the distal end 78 of each of the retention members 73. The body of the retention members 73 is preferably flexible, side to side, to allow insertion of the disk drive 30 into the base 6.

As shown in FIGS. 6A-6G and FIGS. 2A and 2B, the plurality of retention members 73 function to hold the disk drive 30 in the housing 2 and in contact with the support members 74. The body 76 of each retention member 73 extends upward from the base 6 a distance sufficient to engage the top surface of the disk drive 30, when the disk drive 30 is resting on the support members 74. The hooks 79 fit over and engage a top surface of the disk drive 30 and hold the disk drive 30 on the support members 74.

As best shown in FIG. 6K, in an unloaded condition (e.g., when the disk drive is not installed in the base 6) the retention members 73 also extend inward toward the center region of the housing 2 as they extend upward from the base 6 toward the cover 5. The retention members 73 are flexible, side to side. In order to insert the disk drive 30 into the base 6, the retention members 73 are deflected outward toward the sides 9 of the housing 2. When the disk drive 30 is completely inserted, as shown in FIGS. 2A and 2B, it comes to rest on the support members 74. The hooks 79 fit over and engage the top surface of the disk drive 30. The retention members 79 are now in a loaded condition and a pressure is applied inward toward the center of the housing 2 and against the side of the disk drive 30 by the retention members 73. This prevents side to side (e.g., lateral) movement of the disk drive 30 and helps to absorb shocks and vibrations. The hooks 79 positively hold the disk drive 30 in contact with the support members 74 and help to prevent up and down (e.g., vertical) movement of the disk drive 30.

FIGS. 6L and 6M show the interaction between the retention members and the reinforcing members. In operation (e.g., when the cover and the base are connected) the plurality of reinforcing members 44 of the cover 5 are positioned against an upper portion 80 of each of the retention members 73 of the base 6 proximate the hooks 79 and are adapted to prevent the retention members 73 from flexing outwardly toward the sides 9 of the housing 2, thereby positively restraining the disk drive 30 in place in the housing 2 and preventing the disk drive 30 from becoming free of the retention members 73.

The digital imaging device 1 includes an improved disk drive 30 mounting system. Mounting a disk drive in a subsystem has always been a challenge when utilizing a screwless assembly (e.g., snaps). The problem exists during drop and shock testing that a device must pass in order to be qualified for customer shipment. Current designs utilize snaps that hold a cover to a base and sandwich a drive in between the two enclosure halves when the snaps are engaged. During a drop test, and customer simulation for that matter, the entire impact weight of the drive device is transmitted to the snaps causing a great amount of stress and sometime failure to occur in the snap region. To combat this situation, extra effort is put into increased structural design as well as utilize higher impact resistive and more costly material.

A second problem that occurs with existing snap design is that ample clearance around the drive unit needs to be supplied to allow for the various sized drives that would be installed into the unit. The size variation referred to is caused by tolerances that stacked up due to both part variation and assembly variation. This clearance yields an inferior product from a perceived quality perspective in that the drive is allowed to “rattle” if the drive is anything other than maximum size.

A third but less concerning issue is being able to assemble a modular portion or subset of components, capable of being tested prior to final closure of the entire assembly. In many applications of components that are not individually fastened into a subassembly, the inadvertent turning over of the subsystem will allow components to fall out of the unit and therefore damaging components prior to final assembly. Designs that fall into this category many times do not protect the component during assembly in that the final snapping of the top cover onto the base is the only mechanism holding the unit together.

The digital imaging device 1 includes a series of four horizontal supports 88 with side supports 89 that are formed as part of the base 6 to act as a platform or support member 74 for the disk drive 30 unit to sit on. The dimension of these support members 74 is preferably ample to accommodate the range in tolerances of expected drive assemblies. At this point the drive is allowed to “rattle.”

The digital imaging device 1 includes a plurality of long retention members 73 having hooks at their distal ends and which extend from the base 6 unit extending to a height that allows these hooks to latch over the top edge of the drive assembly 30. Preferably, the retention members 73 are positioned at an angle that caused the retention members 73 and hooks 79 to only be in contact at the upper most portion of the drive lip. The angle cause a situation of clearance between the retention members 73 and drive that existed at a minimum at the top of the drive where the hook 79 contacts, to a maximum where retention members 73 extended below the drive unit. At this point, with all components assembled (minus cover attachment), the drive unit is secured sufficiently to allow the subassembly to be transported, turned over, or tested without the danger of the drive falling out of the subsystem and getting damaged.

To enhance the retention members 73, a plurality of reinforcing members 44 (e.g., vertical ribs of substantial structure) were incorporated into the cover 5. The position of the reinforcing members 44 is directly above and slightly outside the form factor of the drive assembly. The purpose of these reinforcing members 44 is to engage, with an interference fit, the retention members 73 mention above. The point of contact is at a location below the contact point of the drive hooks with the drive assembly. The purpose of these reinforcing members 44 is to act as a backup structure to the drive hooks 79, preventing the drive mounting hooks 79 and retention members 73 from becoming disengaged from the top corner of the drive assembly. This allows the drive mount hooks 79 and retention members 73 to take the load of the drive assembly during drop-shock testing. Designing the reinforcing members 44 to be an interference fit promoted the hooks 79 to apply a later force to the drive assembly, and therefore removing the clearance/slop designed into the system to allow for various size drive assembly units.

This improved drive mounting system acts to transfers the direct loading of the enclosure snap during drop shock testing to the drive hooks, that are more controllable from the standpoint of designing for stress application (e.g., the drive snap currently in use have a complex shape whereas the stress induced is a function of tension, bending, and manufacturing weakness caused from molding processes—primary weld/knit lines). Also, retention members 73 and hooks 79 having a simple rectangular cross-section, are much easier to control and design for stress situations. However, other shaped structures could be used, such as oval. This design and construction also allows for the use of cheaper, more main stream materials, because higher strength can be achieved easier with a simple hook design. The interference allows for large range in sizes variation in drive geometry without compromising perceive quality by keep the end product tight in feel for the consumer. In more simple terms, the design allows the system to be more tolerance compliant. In addition, subsystem can be tested or transported prior the final closure of the system, because the drive is maintained in position by drive hooks that fixture the drive prior to cover assembly.

As shown, the plurality of alignment members 48 are disposed between the cover 5 and the base 6 and include a plurality of alignment slots 50 and a corresponding plurality of alignment tabs 75. As shown, the plurality of alignment tabs 75 extend from the partial side walls 9b of the base 6. The alignment tabs 75 are adapted to be received into the corresponding alignment slots 50 on the cover 5 to help align the cover 5 and the base 6 and to help hold the cover 5 and the base 6 together.

As shown in FIGS. 6E through 6G and FIG. 4C, the digital imaging device 1 includes a snap mechanism disposed between the cover 5 and the base 6 and that is used to connect together the cover 5 and the base 6. As shown, the snap mechanism includes four snaps 82, two on each side of the housing 2, and on each side, one being located proximate the front panel 7 and the other being located proximate the rear panel 8. As shown in FIGS. 6A through 6G and FIGS. 2A and 2B, each snap 82 includes a snap body 83 extending generally upward from the base 6 toward the cover 5. Each snap body 83 has a fixed end 84 connected to the base 6, a free or distal end 85, and an opening 86 formed near its distal end. Preferably, the snap body 83 extend above the portion of the side walls 9b formed by the base 6, as shown in the FIGS. Also, as shown in FIG. 6K, the snap body 83 is preferably located outboard of the retention members 73 so that the snap body may be deflected inward toward the center of the housing 2 in order to unlock the snaps 82 and separate the cover 5 and the base 6.

As shown in FIGS. 4B, 4C and 4D, the snap mechanism also includes a corresponding plurality of latches 49 formed on the cover 5 that are adapted to be received within the openings 86 in the snap body 83, thereby mechanically connecting together the cover 5 and the base 6. In an alternate embodiment (not shown), the snap body 83 and the latches 49 may be reversed, such that the snap body 83 extend downward from the cover 5 toward the base 6 and the latches 49 are formed on the base 6. Preferably, the latches 49 are formed on the portion of the cover 5 that forms part of the side walls 9 and extends inward toward a center of the housing 2 a distance sufficient to extend though and engage the openings 86 in the snap body 83. Also, the snap body 83 are preferably flexible, side to side, in order to allow allowing deflection of the snap body 83 inward toward the center of the housing 2 so that the latches 42 may be disengaged from the openings 86 of the snap bodies 83 thereby allowing the cover 5 and the base 6 to be separated. In this regard, the housing 2 includes a corresponding plurality of apertures 87 formed in the sides 9 of the housing 2, preferably proximate the split line between the cover 5 and the base 6 and outboard of each snap body 83. The apertures 87 allow a tool (not shown), such as a shim piece, to be inserted into the assembled housing 2 to deflect the snap bodies 83 inward thereby separating the cover 5 and the base 6.

As best shown in FIGS. 6A through 6G, the plurality of retention members 73, a plurality of alignment tabs 75, and a plurality of snap bodies 83 preferably extend upward a sufficient distance such that they extend above the partial side wall 9b of the base 6. This allows the plurality of retention members 73 operate in conjunction with the corresponding plurality of reinforcing members 44 extending downward from the cover 5 thereby reinforcing the retention members 73, the plurality of alignment tabs 75 to extend into and be received by the alignment slots 5 0 of the cover 5 thereby helping to locate and hold the cover 5 and the base 6, and the plurality of snap bodies 83 to extend up to and engage the latches 49 of the cover 5 so that the latches 49 snap into the openings 86 form in the snap bodies 83 thereby holding the cover 5 and the base 6 together.

As shown in FIGS. 6A-6G, the digital imaging device 1 includes a plurality of support members 74 for receiving and supporting the disk drive 30 in the base 6. As shown, the base 6 includes four support members 74, two on each side 9 of the housing 2, and on each side, one being located proximate the front panel 7 and the other being located proximate the rear panel 8. As shown, each support member 74 has a horizontal surface 88 and a vertical surface 89. When the disk drive 30 is inserted into the base 6, the bottom surface of the disk drive 30 rest upon the horizontal surface 88 of each support member 74 and the sides surfaces of the disk drive 30 contact the vertical surface 89 of each support member 74. The support members 74 help to support the disk drive 30 in spaced relation with the main processing board 35 within the housing 2. The support members 74 also have a second horizontal surface 88a and a second vertical surface 89a for supporting and hold the main processor board 35 in place within the housing and in spaced relationship with the base 6.

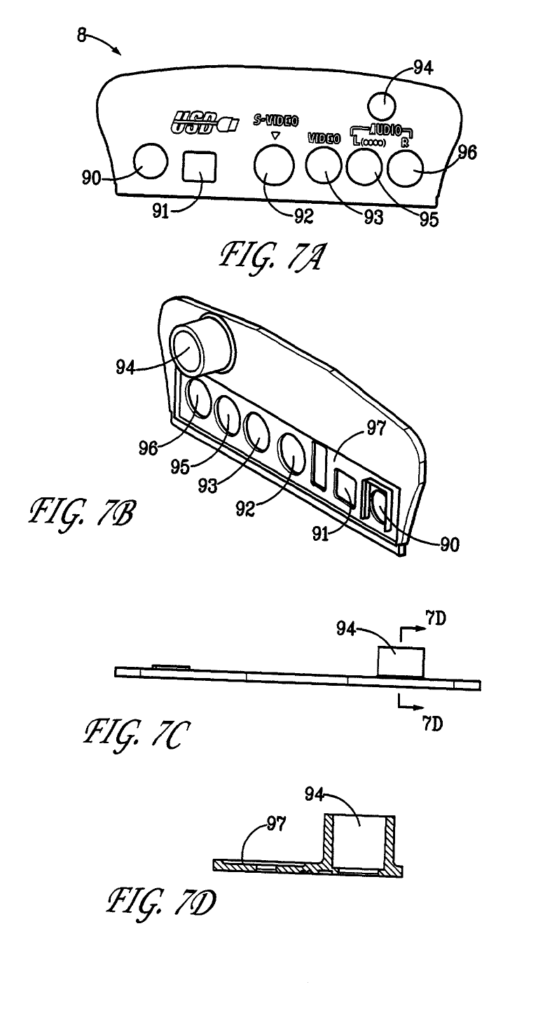

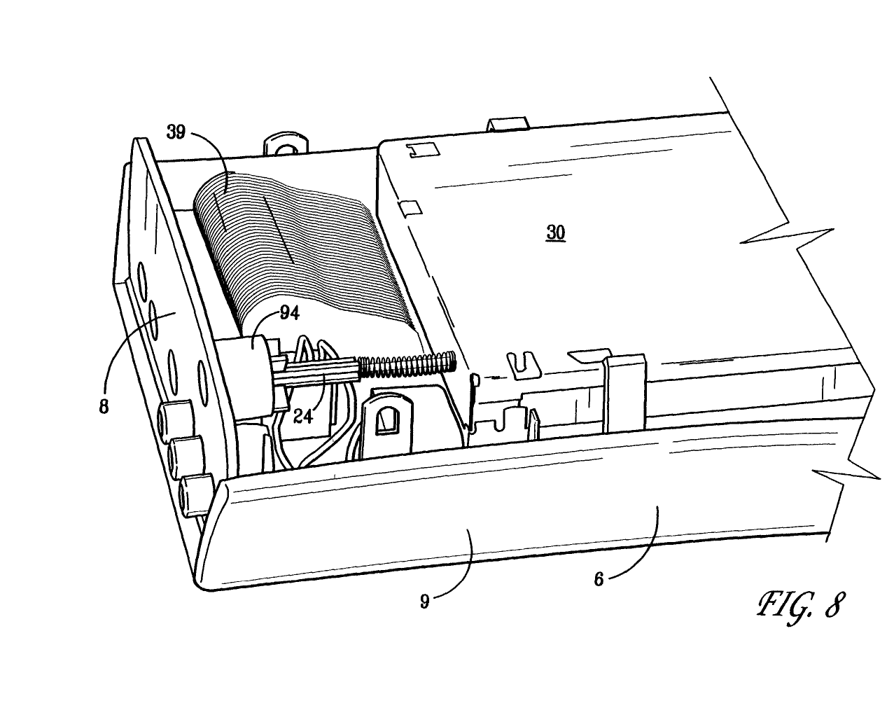

FIGS. 7A through 7D show the rear panel 8 of the housing 2. As shown, the rear panel is a separate piece that is attached to the cover 5 and the base 6, however, it should be understood that the invention is not so limited and that the rear panel 8 can be made integral with either the cover or the base or a portion of the rear panel 8 may be incorporated into the cover and the base. The rear panel 8 includes a plurality of apertures for the various controls and interface connectors of the digital imaging device 1. As shown in FIGS. 7A and 7B, a power connector opening 90 is provided for connection to a power cord to supply electrical power to the digital imaging device 1. An USB connector opening 91 is provided for use in connecting the digital imaging device 1 to a computer. A S-Video (S-VHS) connector opening 92 and a Composite (RCA) Video Out connector opening 93 are provided in the rear panel 8. A no power (e.g., emergency) disk eject button tunnel 94 is provided for ejecting a disk when power has been lost. Preferably, the disk eject button tunnel 94 extends into the housing, as shown in FIGS. 7B, 7C, and 7D, to act as a guide for the no power eject button 24. A left (Mono) audio channel out connector opening 95 and a right audio channel out connector opening 96 are also provided on the rear panel 8, as shown in FIGS. 7A through 7D. A recess 97 may be formed on the inside surface of the rear panel 8 to help align and position the various connectors.

FIG. 8 shows the location of an exemplary no power eject button 24. As shown in FIG. 8, the no power eject button 24 is positioned between the rear panel 8 and the back of the disk drive 30. One end of the no power eject button 24 is located in the tunnel 94 and the other end is located in the disk drive 30.

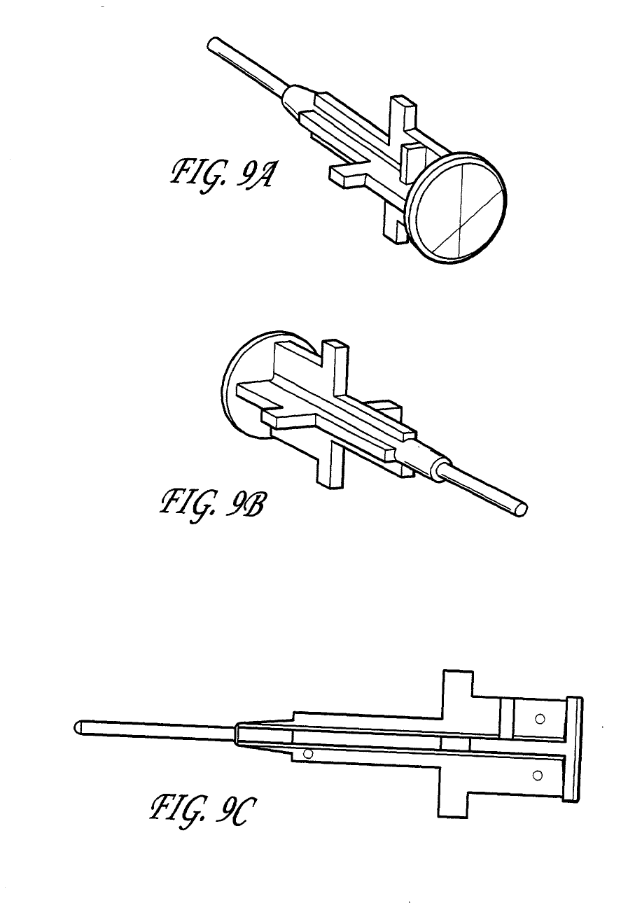

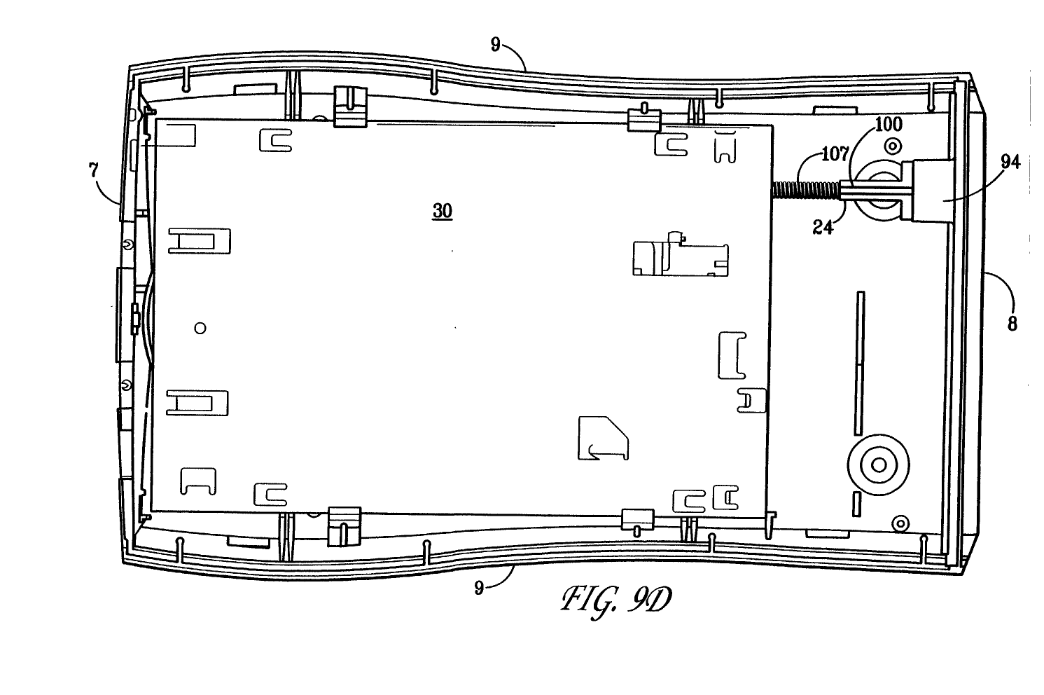

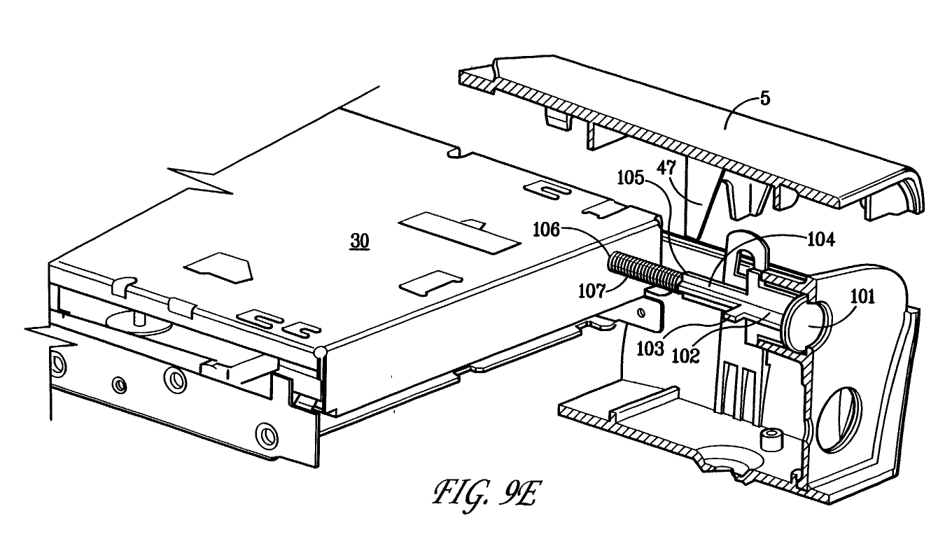

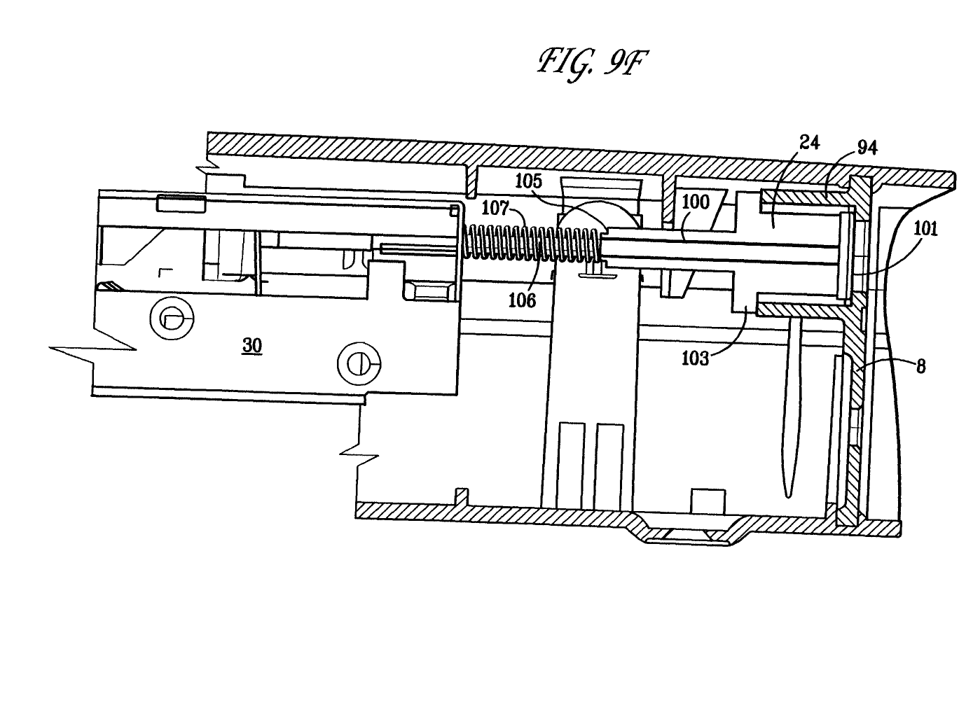

FIGS. 9A through 91 show the no power ejection button 24. As shown in FIGS. 9A through 91, the no power ejection button 24 includes a plunger 100 having a head 101 and piston portion 102 form at the rear most end, a stop 103, a narrow middle portion 104, a shoulder 105, and a pin portion 106. The head 101 and piston portion 102 are positioned within the tunnel 94 and the plunger 100 extends from the rear panel 8 toward the disk drive 30. The stop 103 is adapted to travel between and contact the tunnel 94 or the slotted walls of guide member 47. The middle portion 104 is provided as a transition piece between the piston portion 102 and the pin portion 106. The pin portion 106 extends through a hole (not shown) in the back of the disk drive 30.

In the digital imaging device 1, the user needs to be able to retrieve their Zip cartridge from the disk drive 30 in the event that either the power went out or no power is available to the unit. Preferably, the disk drive 30 used the digital imaging device 1, already has a feature at the rear of the unit that allows the user to insert a paper clip and eject the cartridge. However, a problem exists in that, due to the construction of the digital imaging device 1, the paper clip hole in the back of the disk drive is approximately 1½ inches from the rear panel 8. Previous products have tried extending long guides to guide a paper clip, but still have a problem dealing with the tolerances dictating the location of the paper clip hole. In addition, the digital imaging device 1 is portable and the likelihood of the user having a paper clip readily available has lessened. Therefore, the digital imaging device 1 provides a no power eject button 24 that allow the user to eject the cartridge in the event of no power to the disk drive. Also, the digital imaging device 1 preferably accomplishes this while still allowing the user to eject cartridge with instruments that would most commonly be available to the consumer, such as, for example, keys, pens, pencil, and the like. In addition, the no power button 24 is easy to assemble, adds minimum cost to the digital imaging device 1, and does not interfere with the function of the disk drive 30.

The no power button accomplishes this by providing a design that incorporates an extended no power eject button 24 and guide mechanism (e.g., tunnel 94, guide member 47, and the hole in the back of the disk drive) from the rear panel 8 forward to, and inside, the hole provided in the back of the disk drive 30 for ejecting a cartridge with the pin portion 106 of the no power eject button 24. The no power button 24 includes a plunger 100, preferably designed and molded from an inexpensive plastic material, or the like. The design incorporated one end, the pin portion 106, similar in size to a paper clip, and at the other end, or head 101, design substantial in size to allow for the use of either a pen, pencil, or typical keys to be use to activate the device. The rear most portion, or head 101, was design as to utilize a piston (e.g., piston portion 102) in a cylinder (e.g., tunnel 94) type configuration therefore allowing the user to activate the mechanism with common found items and ejecting the cartridge from the unit. A spring 107 surrounds the narrow pin portion 106 and is position between the back of the disk drive 30 and shoulder 105 of the plunger. Spring 107 functions to bias the plunger 100 toward the rear 8 of the unit, thereby returning the no power ejection button 24 to a non-operating position.

In operation, a user depresses the no power ejection button 24 using an extended object, such as, for example a pencil, a pen, or the like. The no power ejection button 24 travels inward toward the disk drive 30, as shown in FIGS. 9G, 9H, and 9I. The distal end of the pin portion 106 activates an ejection mechanism (not shown) within the disk drive 30 and the disk is ejected from the disk drive 30. The stop 103 prevents over depression of the no power ejection button 24 thereby limiting the distance that the no power ejection button 24 may travel into disk drive in order to prevent damage to the disk drive 30.

Assembly of the no power button is accomplished through installing the spring 107 over the narrow pin portion 106 of the plunger 100 and then inserting the pin portion 106 through the rear opening on the disk drive. Once compressed sufficiently, the larger head end 101 of the plunger 100 can be inserted into the cylinder portion of the tunnel mechanism 94 located in the rear panel 8. Accidental over travel during operation is prevented by the addition of a guide member 47 having a slotted wall (e.g., a substantially U-shaped member extends downward from the cover) that protrudes and extends from the cover 5. Once installed the slotted wall of the guide member 47 prevents the plunger 100 from being activated beyond its intended travel.

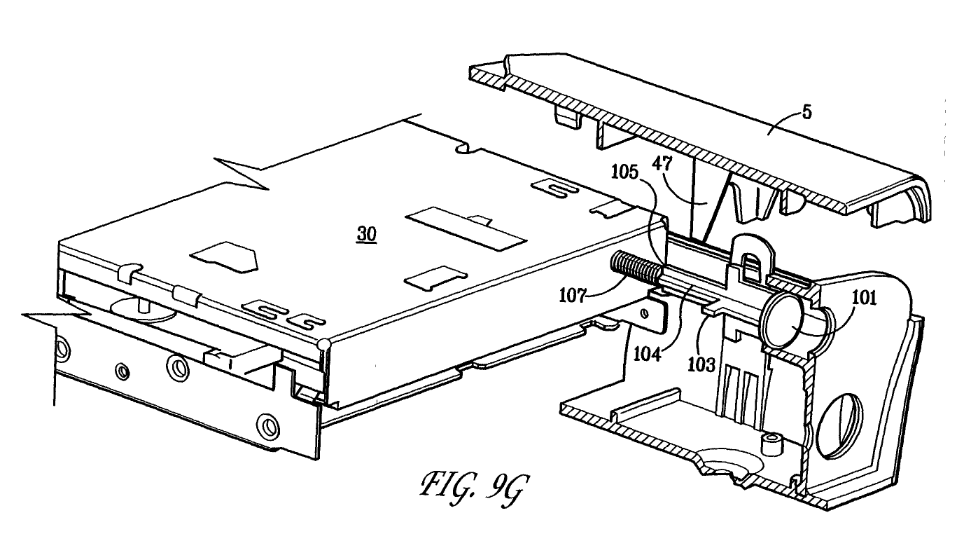

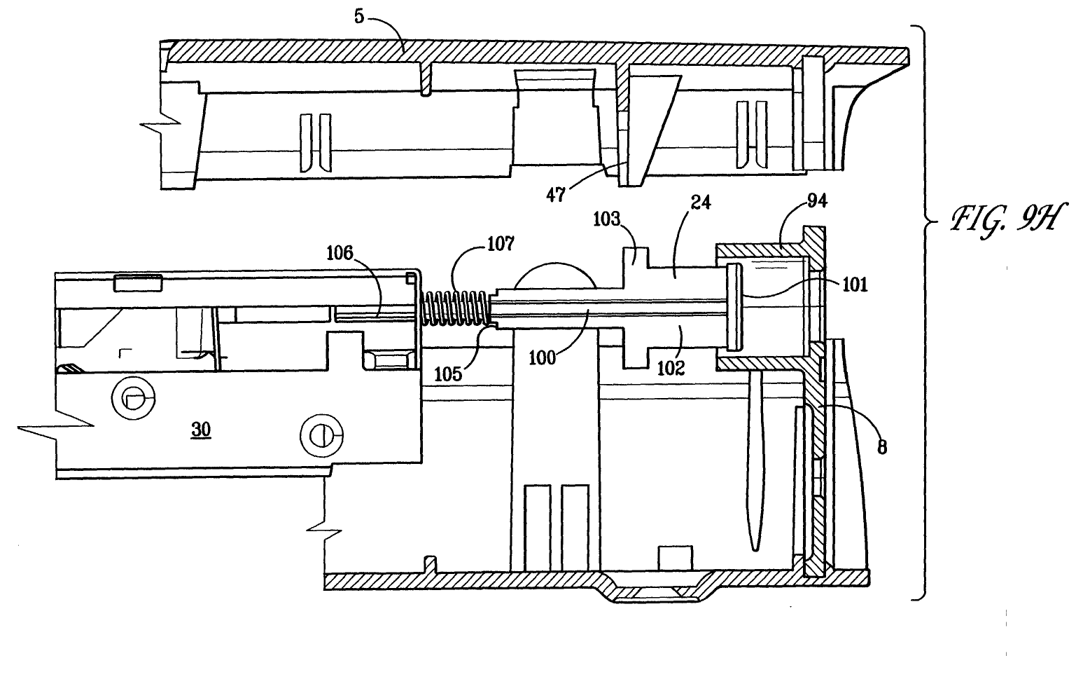

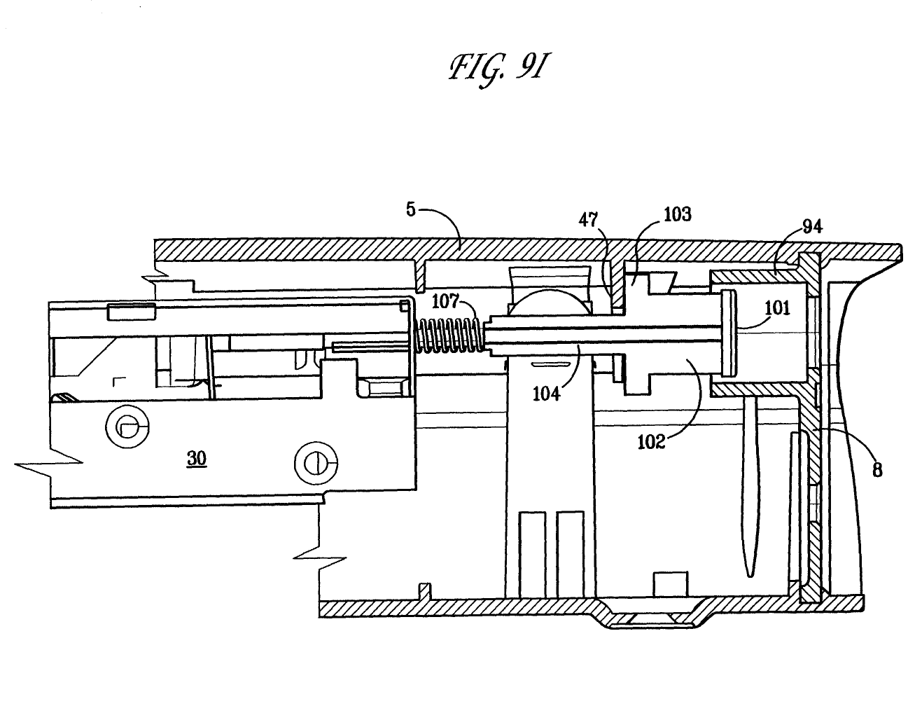

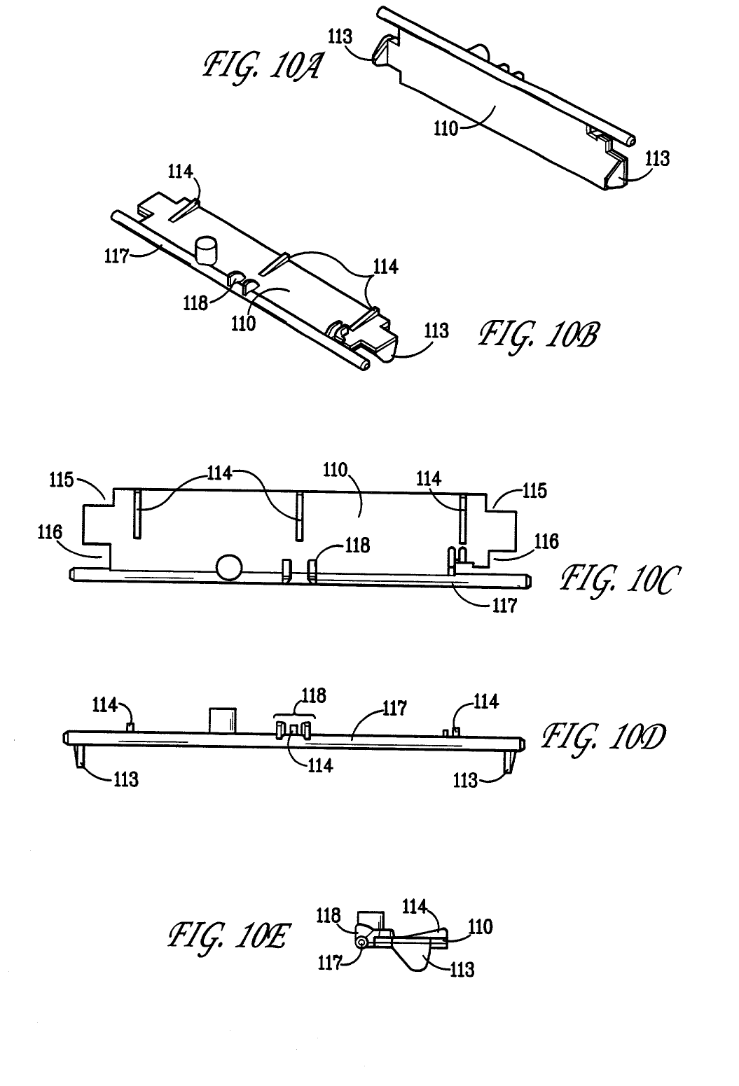

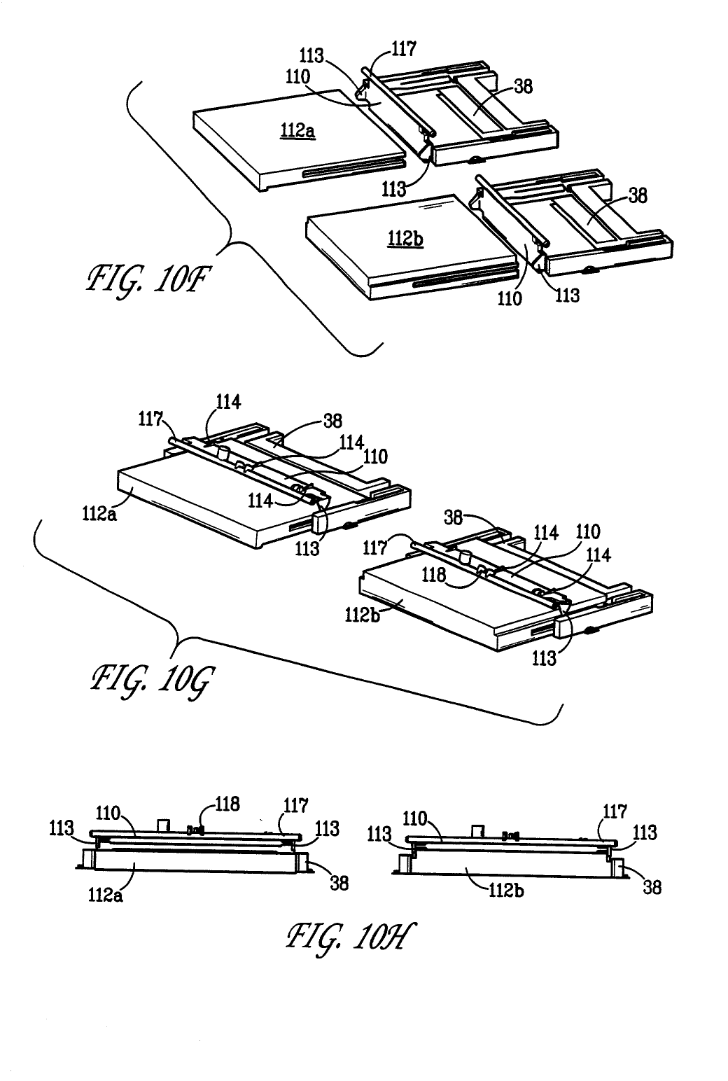

FIGS. 10A through 10I show an exemplary compact flash door 110. As shown, the compact flash door 110 is located inside the front panel 7 and covers the compact flash form factor slot 11. The compact flash door 110 includes a hinge mechanism 111 that allows the compact flash door 110 to rotate out of the way so that a compact flash compliant device 112 (Type I or Type II), such as, for example, a CompactFlash™, may be received within the compact flash form factor slot 11. The compact flash door 110 includes a plurality of guide ribs 113, a plurality of ribs 114, a pair of upper notches 115, a pair of lower notches 116, and a rod 117. The rod 117 is support on each end by corresponding door support members formed on the front panel 7. Preferably, the rod 117 has a circular cross section. A centering mechanism 118 may be provided on the rod 117 and in conjunction with a centering tab on the front panel 7, acts to center and align the compact flash door 110 over the compact flash form factor slot 11.

As shown in FIGS. 10F through 10I, the digital imaging device 1 utilizes a slot 11 and socket receptacle 38 that accepts the insertion of the either a Type I or a Type II Compact Flash compliant (e.g., form factor) device through slot 11 in the front panel 7. However, a problem exists when trying to guide a Type I device through the opening in such a fashion as to prevent the Type I device from being angled up therefore missing the socket that the device is plugging in to. A Type II device is the same dimensions as Type I device with the addition that the center section has an increase thickness. Conventional devices do no use the same slot for both Type I and Type II because most attempts to add guidance features to guide a Type I device in turn prevent a Type II device from being inserted. The digital imaging device solves this problem by providing a compact flash door that guides a Type I onto the provided electrical socket without hindering the use of a Type II device and still providing adequate coverage of the compact flash slot 11.

In order to accommodate and be compliant with both Type I and Type II devices 112a, 112b, the compact flash door 110 includes two guide ribs 113 that are preferably located at the extreme ends of the door 110. The guide ribs 113 act as a guide to contact the portion of the Type I device 112a that is common with the Type II device 112b. The width between the guide ribs 113 is preferably maintained at a dimension larger than the maximum width dimension on the portion of the Type II device 112b that differs from the Type I device 112a. The height of the guide ribs 113 is preferably equivalent to different in height between the Type I and Type II device 112a, 112b as applied to the compact flash door 110 when it is at the operated opening angle (which is not necessarily 90 degrees, and in the preferred embodiment is about 80 degrees).

In addition, the back side (e.g., non-visible side) of the door 110 includes a plurality of ribs 114 designed to butt up against the disk drive 30 inside the digital imaging device 1, thereby forming a hard limit for the opening motion of the door 110. Note that the disk drive 30 as the structure that the ribs but up against could be replaced with any rigid structure inside the unit capable of performing a similar function as the drive.

This design and construction of the compact flash door 110 provides the advantage that the compact flash door 110 acts to guide a Type I Compact Flash device 112a with hindering the insertion of a Type II Compact Flash form factor device 112b. The design provides a special door design, therefore keeping the functionality of having a compact flash door 110 to cover the front opening (e.g., slot 11) of the digital imaging device 1.

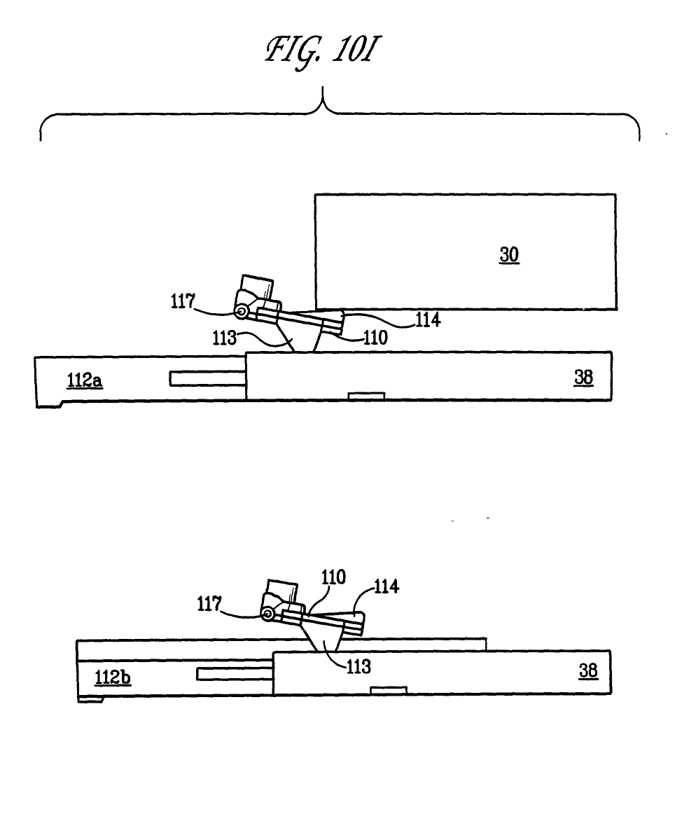

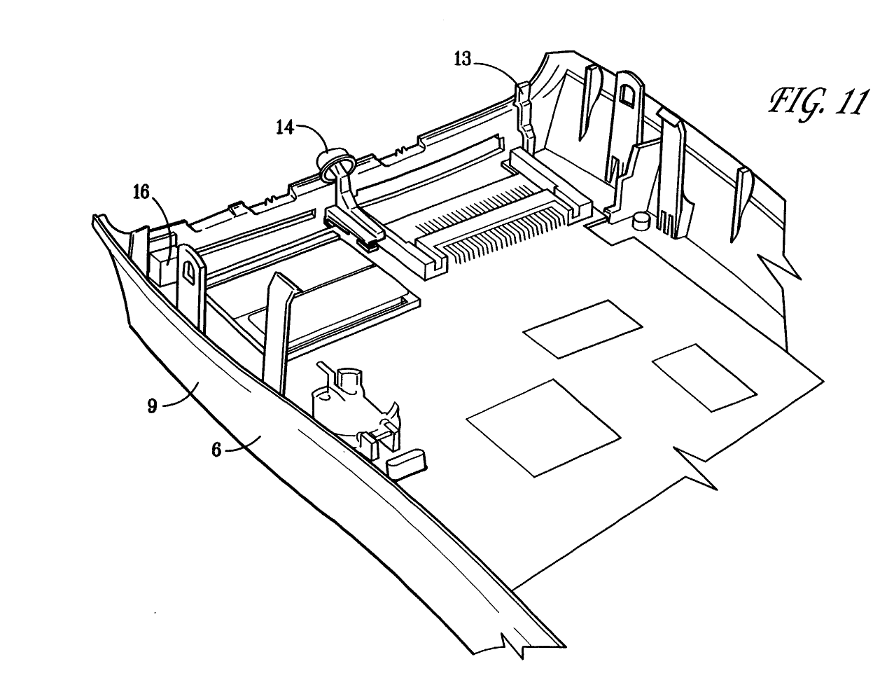

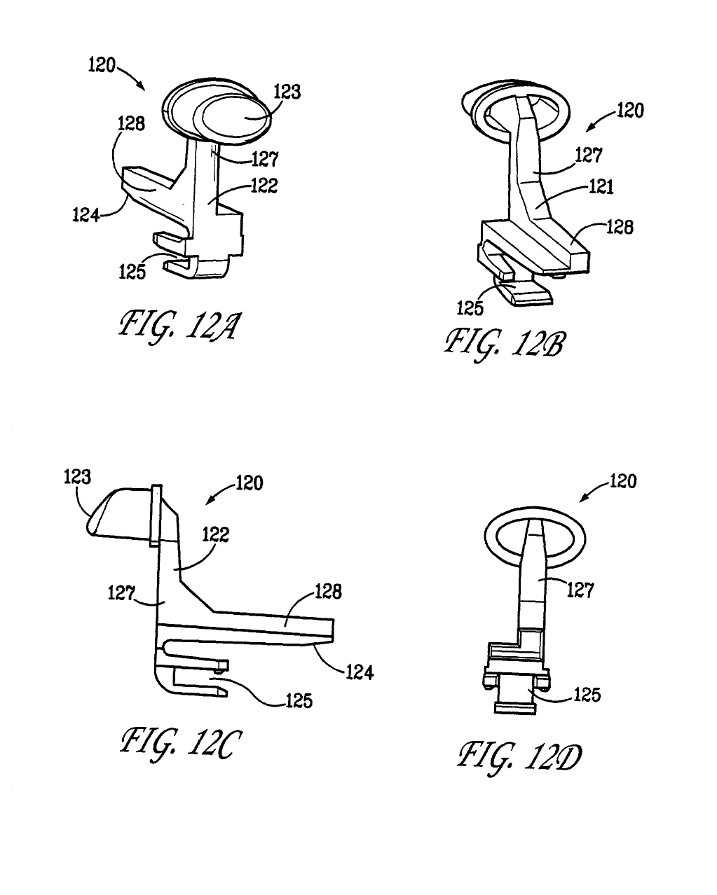

FIGS. 12A through 12D show an exemplary copy button 120. As shown in FIGS. 12A through 12D, the copy button includes a dual functionality in that it acts as a button for activating a copy switch mounted on the main processing board 35 and also acts as a light pipe for communicating light from a light source on the main processing board 35 to the opposite end of the copy button 120 thereby illuminating the copy button 120. The copy button 120 includes a hinge mechanism that translates a substantially horizontal motion into a substantially vertical motion. For example, as a user pushes the front surface of a button portion 120, the horizontal pushing force is translated, through the hinge mechanism 121 down a vertical member 127 of the body into a horizontal member 128 of the copy button 120, into a vertical force that act at the switch surface 124 at the opposite switch activation end 129 of the copy button 120 thereby activating a switch disposed below the switch surface 124. A clip 125 is provided on the bottom of the copy button 120 for securing the copy button 120 to the main processing board 35.

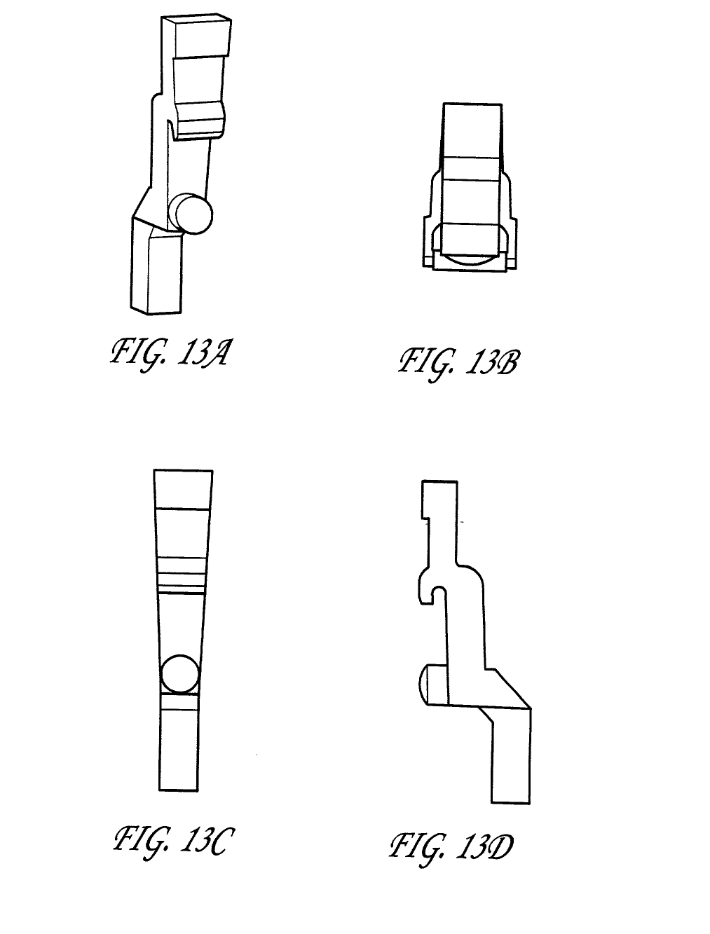

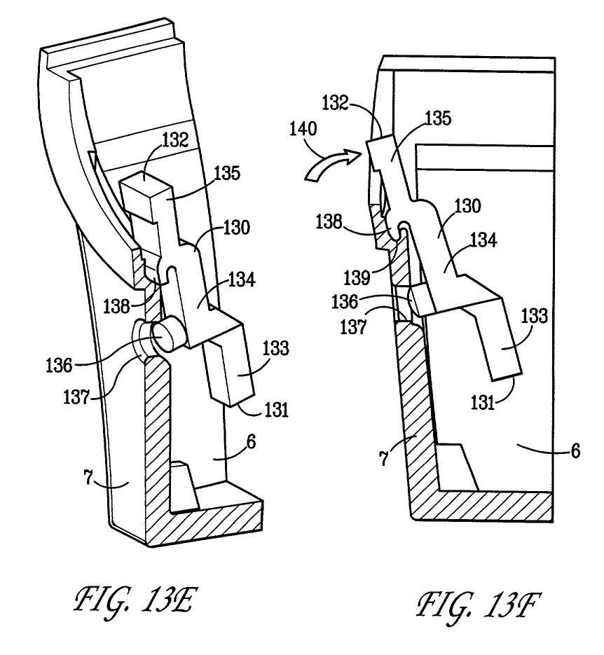

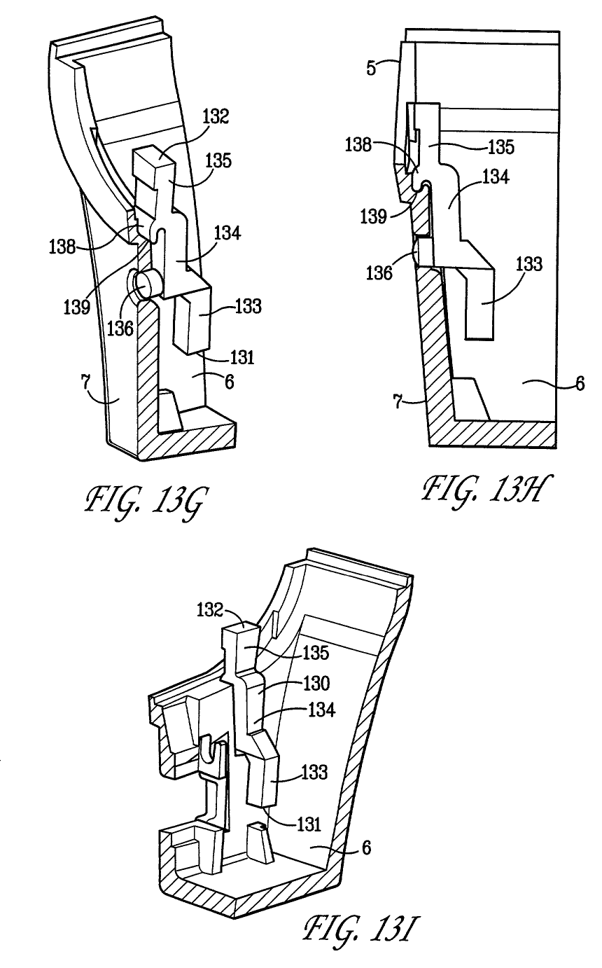

A light pipe 130 for transferring light from an LED, internal to the housing 2 is desired on the digital imaging device 1, such as for example, to indicate that power is available to the unit. FIGS. 13A through 13I show an exemplary power light pipe 130. The power light pipe provides an improved light pipe snap for use with the digital imaging device 1. As shown in FIGS. 13A through 13I, the power light pipe includes a first end 131, a lower portion 133, a middle portion 134, an upper portion 135, and a second end 132. A protruded portion 136 extends from the middle portion 134 and is adapted to extend into an opening 137 in the front panel 7 and illuminates when power is being provided to the unit.

The improved light pipe 130 includes a light pipe that is installed by rotating the light pipe until it snaps into place. In addition, the light pipe 130 can be assembled after the PCA that it is positioned above is installed, is removable to allow for rework should the PCA need to be removed, can withstand the shock requirement of the product, and does not introduce any additional side actions or undercuts to the base enclosure 6 that the light pipe 130 is attached to.

As shown in FIGS. 13A through 13I, the light pipe 130 of the present invention includes a hook feature 138 designed onto the light pipe 130. This hook feature 138 furthermore was dropped into a pocket 139 that was molding into an edge wall on the base 6 enclosure plastics. FIGS. 13E and 13F show the light pipe 130 as it is being rotated into position. The light pipe 130 is rotated up and back in the direction of directional arrow 140, as shown in FIG. 13F. Once the hook 138 on the light pipe 130 is installed into the pocket 139, the light pipe is rotated into position, and a cylindrical feature that allows light to pass through, directs the light through a cylindrical hole in the protruded portion 136 and through the front of the base unit. Preferably, an interference is designed in, such that the distance from bottom of pocket 139 in the base edge to the closest edge of the cylindrical hole is greater than the distance from the hook tip that contacts the bottom of the pocket 139 and the closest edge of the cylindrical section of the light pipe 130 that passed through the base hole. The snapping action of the light pipe as it is assembled is enhanced by the fact the light pipe has to fit around the hypotenuse of the triangle formed from pocket, to a point on the cylindrical hole perpendicular to the pocket, to a point where the cylindrical hole breaks through the interior surface of the base.

When fully assembled, the cover 5 ends up being disposed over the upper portion 135 and prevents the upper portion form rotating forward toward the front panel. The combination of the round post on the bottom which has to go through as the light pipe itself, the upper hook which hold the light pipe in the base itself, and the cover 5 which keeps it from being able to pivot out in the opposite direction that it was assemble. This design and construction where the light pipe is attached to the base, and not the board 35, assists in the manufacturing and assembly, and is easily removed and added at will. This design also avoids any carved undercuts in the back side of the light pipe which is undesirable.

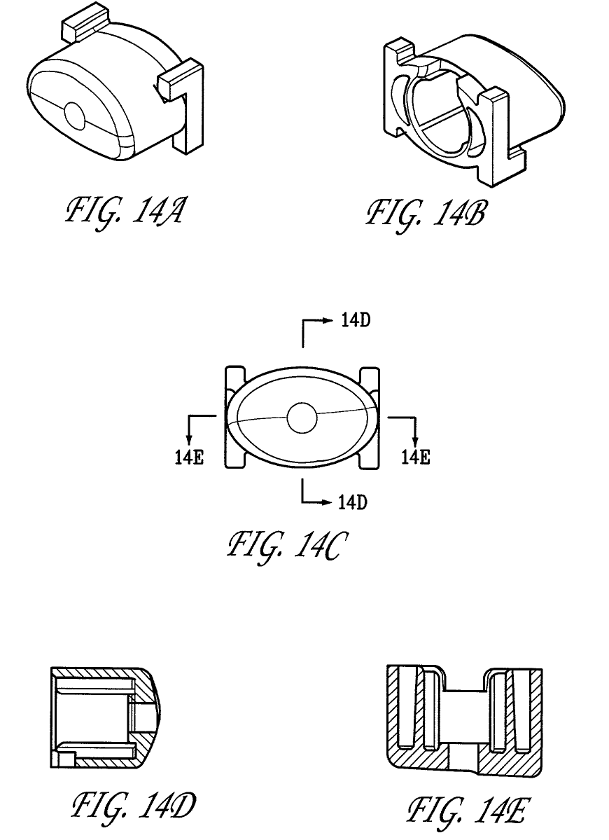

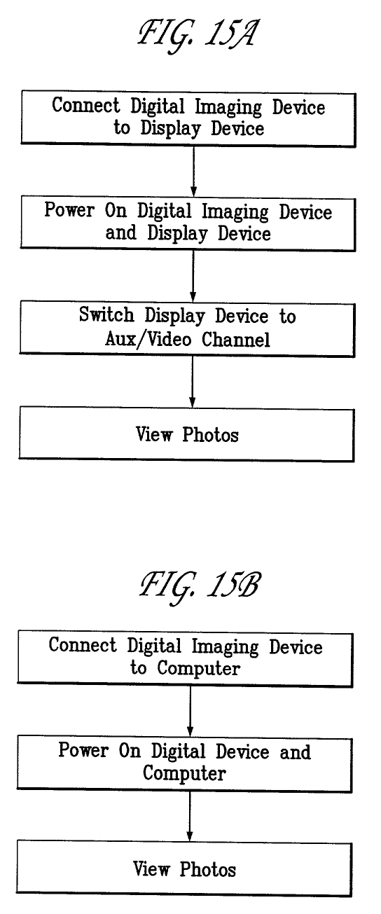

FIG. 14A through 14E shows the features of the disk ejection button.

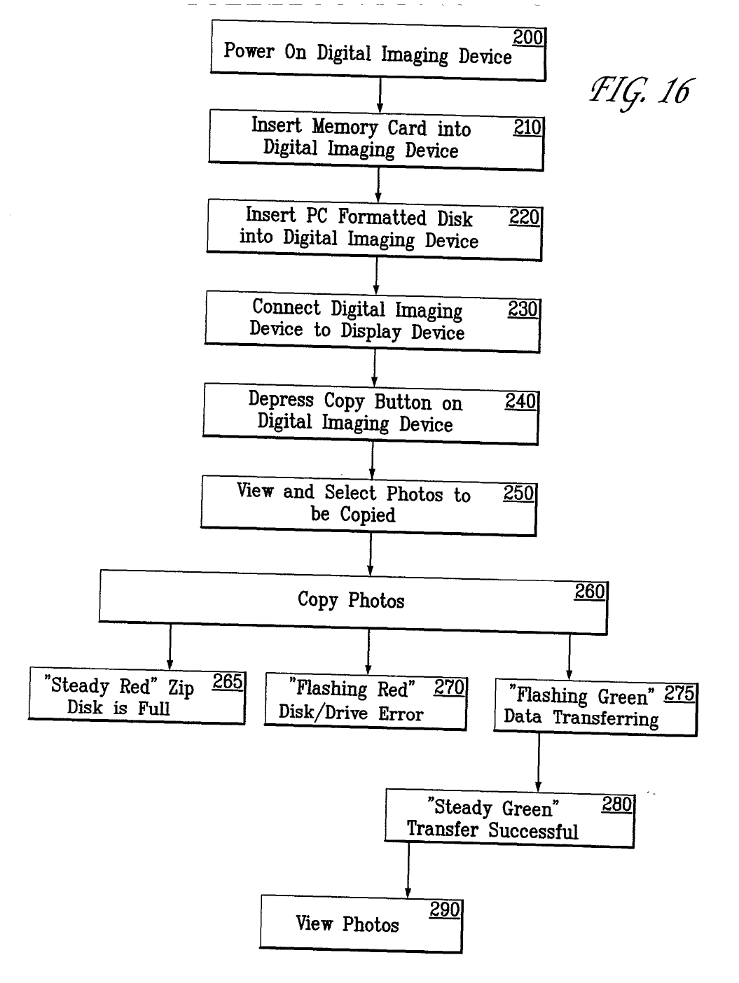

FIGS. 15A and 15B are block diagrams showing exemplary processes for connecting the digital imaging device 1 to a display device, such as, for example, a television (TV), a computer, or the like. A typical connection includes connecting the digital imaging device 1 to a TV, VCR, AV receiver, or the like. Preferably, the TV complies with NTSC which is the television standard used in, for example, the United States, Japan, and Canada. A set of cables, such as RCA type cables, can be used for this purpose. Most TVs have RCA type connectors.

Providing the display device has RCA connectors, the RCA connectors can be used by connecting the yellow RCA cable to the yellow RCA VIDEO IN connector on the back of your TV, VCR, or AV receiver. The yellow RCA cable is connected to the yellow RCA VIDEO OUT connector on the back of the digital imaging device 1. The RCA audio connector is connected to the AUDIO IN connector on the back of the TV, VCR, AV receiver, or stereo system. Care should be taken to ensure that the white cable connector is matched with the white (left, mono) AUDIO IN connector on the back of the TV, VCR, AV receiver, or stereo system. If the display device that the digital imaging device 1 is being connected to has stereo sound a red (right) AUDIO IN connector may also be included. The red cable connector is connected to the red AUDIO IN connector. The RCA audio cable is connected to the audio connectors on the back of the digital imaging device 1. Again, care should be taken to ensure that the white cable connector is matched with the white (left, mono) AUDIO OUT connector on the back of the digital imaging device 1. If the Red (right) RCA connector has been connected, make sure that the red cable connector is connected to the red (right) AUDIO OUT connector on the back of the digital imaging device 1. The power supply is connected to the digital imaging device 1 which may then be plugged it into an electrical outlet. The POWER button is then pressed on the digital imaging device 1. The power light on the front of the digital imaging device 1 should illuminate after the power supply cable has been connected. The TV set is then turned on and set to the appropriate video input. For example, most TVs will have either AUX (auxiliary) or VIDEO input channels and many TV remote controls have either a TV/VCR or a TV/VIDEO button that changes the video input. Accordingly, the type of display device may determine the appropriate video input channel. If the audio channel has been connected to a stereo or AV receiver, then it should be turned on. The Zip® disk is inserted into the digital imaging device 1 and operation of the digital imaging device 1 may begin.

The digital imaging device 1 is also compatible with other types of connections. For example, the digital imaging device 1 can be attached to almost any type of TV. If the TV does not have RCA connectors, as described above, several alternative connection types may be appropriate. This can be determined by referring to the manual that came with the display device (e.g., the TV, VCR, or AV receiver) or by looking at the back of the display device to determine the type of connectors that are available. Select the appropriate connector for the particular display device. Several alternative connection types are described below.

The digital imaging device 1 can be connected to a TV or VCR using a S-Video cable (not shown). S-Video carries a higher quality video signal than the RCA connector; however, only high end TVs typically have S-Video connectors. Also, S-Video cables carry video only, and therefore, the red and white connectors of the RCA cable are required to hear any sound. Some TVs do not have either RCA or S-Video connectors and therefore may require an RF modulator (not shown) to connect the digital imaging device 1 to some TVs. The RF modulator hooks into the TV's standard antenna connector.

Another feature of the present invention is an auto adapter. The auto adapter allows the digital imaging device 1 to be connected to a cigarette lighter or power outlet in a vehicle, such as a car. Generally, the digital imaging device 1 will be used as a stand-alone device when it is connected to the auto adapter. When used as a stand-alone device, the content of a digital camera's SmartMedia™ or CompactFlash™ card can be transferred to the Zip® drive of the digital imaging device 1. The auto adapter allows digital photos to be transferred to a Zip® disk thereby allowing reuse of the camera's digital storage while in the field (e.g., away from home) without having to replace the expensive digital film card(s).

To use the auto adapter, connect the auto adapter to the power connector on the digital imaging device 1 and then plug it into a vehicle's cigarette lighter or power outlet. Insert a Zip® disk and SmartMedia™ card, CompactFlash™ card, or IBM® Microdrive™ into the appropriate slot in the digital imaging device 1. Press the copy button to transfer the digital photos to the Zip disk.

FIG. 17C shows an exemplary process for copying digital image files between a solid state memory, such as a compact flash or smart media, of a digital camera and the digital imaging device 1. The digital imaging device 1 provides a relatively simple way to copy digital photos from relatively expensive digital film, such as, for example, SmartMedia™, CompactFlash™, Microdrive™, and the like, onto relatively inexpensive data storage medium, such as, for example, portable Zip® disks. The digital imaging device 1 preferably allows for several copy modes, such as selective copies when hooked to a TV set or copying of the entire contents of the digital film to the data storage medium.

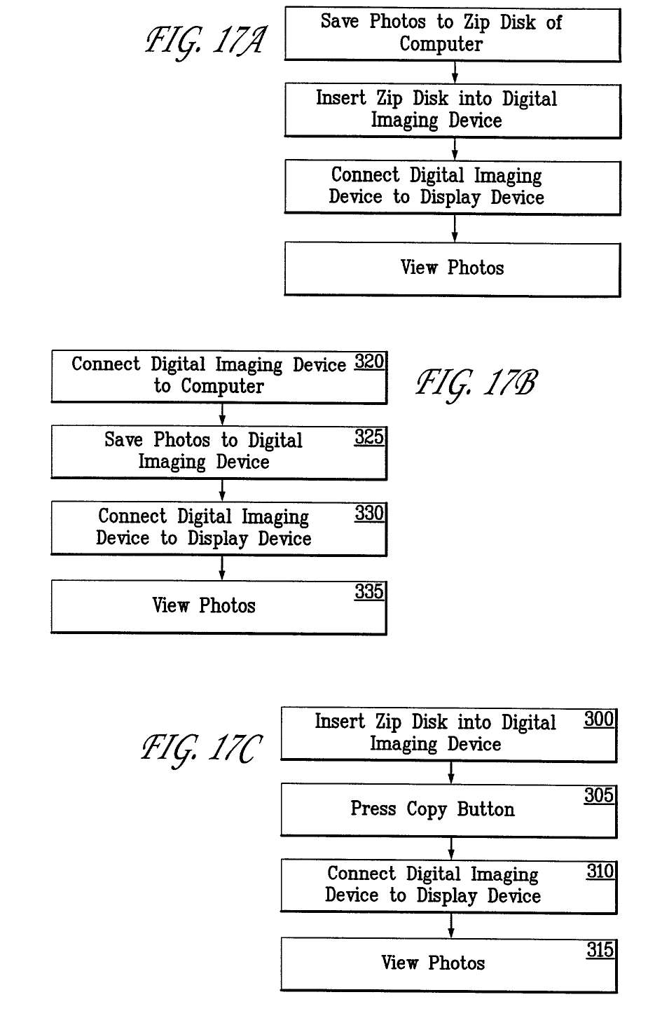

As shown in FIG. 16, when the copy button is pressed, it will light up. The light reports the status of the data transfers to the Zip drive. The light will stay on until the status of the transfer changes or another copy is started. For example, when a copy is completed successfully the light will stay on until the next copy begins. Preferably, a flashing green light indicates copy in progress, a solid green light indicates copy successful completed, a flashing red light indicates that there is not enough space on the Zip® disk (e.g., no files copied), a solid red light indicates that the copy has failed. The user can verify all media and try the copy again.

In one embodiment of the present invention, the digital imaging device 1 provides for selectively copying of the digital image data between the digital film and the data storage medium. The digital imaging device provides a simple way to transfer only the photos between the digital camera and the Zip® disk. FIG. 16 illustrates the basic steps for transferring the digital data to the Zip® disk. Turn on the digital imaging device by pressing the power button, at step 200. Insert the 3.3 v SmartMedia or CompactFlash card into the appropriate card reader slot on the digital imaging device, at step 210. Insert a PC-formatted disk into the Zip® drive of the digital imaging device, at step 220. For this type of copying to be performed, the digital imaging device is preferably hooked to a TV or the like, at step 230. A user presses the copy button, at step 240. The digital imaging device will display photos from the specified digital source (e.g., SmartMedia™, CompactFlash™, Microdrive™, etc.). A display device is used to view and select one or more pictures for copying, at step 250. Once the desired photos have been selected, the selected photos are copied from the selected digital source to the Zip® disk, at step 260. Preferably, in a default setting, all photos are selected for copying if the user does not select photos for copying. The digital imaging device will copy all of the JPEF files (e.g., the digital data) on the memory card to the Zip® disk. The light in the copy button will flash green while the digital data is being transferred, step 275. When the data transfer is complete, the copy button will glow green if the transfer was successful (step 280), red if there was a disk or drive error (step 265), or flash red (step 270) if the Zip® disk is full.

Alternatively, the digital imaging device provides for a simply way of copying all the photos at one time. FIG. 17C shows an exemplary process for copying all of the contents of the digital film and, as shown, involves little more than inserting the media to be copied into the digital imaging device and pressing the copy button. The digital imaging device is turned it on by pressing the power button. Insert the 3.3 v SmartMedia or CompactFlash card into the appropriate card reader slot on the digital imaging device, at step 300. Insert a PC-formatted disk into the Zip® drive. Press the copy button, at step 305, to copy only the JPEG images from the digital film to the Zip® drive. The light in the copy button will flash green while the data is being transferred. When the data transfer is complete, the copy will glow green if the transfer was successful, red if there was a disk or drive error, or flash red if the disk is full. No viewing of the photos occurs during copying. To view the copied photos, connect the digital imaging device to a display device at step 310. View the photos at step 315.

The digital imaging device 1 also provides for adding photos from a computer. FIGS. 17A and 17B illustrate an exemplary process for transferring digital data between the digital imaging device 1 and a computer. As shown in FIG. 17B, the digital imaging device is connected to a computer using an appropriate connector device, at step 320. Note, if the computer is already equipped with a Zip® drive, then a Zip disk may be inserted into the computer drive. Save the JPEG photos or images to the Zip® disk, at step 325. Preferably, the digital imaging device is compatible with most JPEG formats. JPEG is the most common file format used by digital cameras. Some non-JPEG images (such as, for example, BMP, PICT, GIF, PNG, EPS, or TIFF) may require the use of a computer to convert them to a compatible JPEG format. Disconnect the digital imaging device from the computer and connect it to a display device, such as a television. If the computer Zip® drive was used above, then remove the Zip disk and insert it into the digital imaging device connected to a television. To view the copied photos, connect the digital imaging device to a display device at step 330. View the photos at step 335. FIG. 17A shows the process of copying wherein the disk drive of the computer is used to control the copying process. FIG. 17B shows the process of copying wherein the microprocessor of the digital imaging device is used to control the copying process.

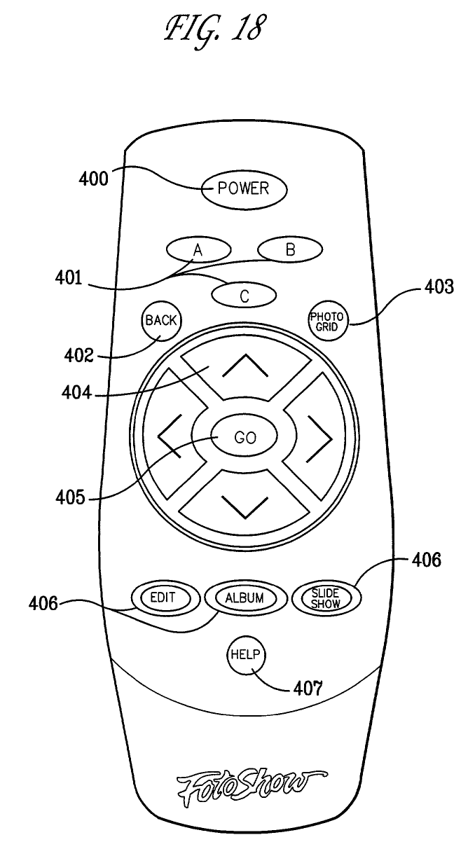

The digital imaging device includes a remote for controlling the operation of the device. The remote allows a user to organize, edit, view and copy digital data between the digital imaging device and a viewing environment, such as a TV. As shown in FIG. 18, the remote includes a plurality of buttons including, a Power Button 400, which activates the device 1, an A, B, and C Buttons 401, that perform context-sensitive tasks in the device's software, a Back Button 402 that cancels the current task and returns to the previous screen, Phot Grid Button 403 that accesses the Photo Grid screen or marks all photos when in the Photo Grid screen, Directional Navigation (arrow) Buttons 404 which is used to make on-screen selections, a Go Button that selects current options, Menu Buttons, including the Edit, Album, and Slideshow buttons, and a Help Button which accesses the devices software's on-screen help system.

The digital imaging device also includes the appropriate Software for organizing, editing, viewing, and copying digital data using the digital imaging device. For example, the software can be divided into three easy-to-use sections, including the album gallery, the editing room, and the slideshow organizer. Each of these “rooms” has a unique set of tools to help a user organize, enhance, and view digital photos. Preferably, these icon-based toolbars are intuitive to use.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed is:

1. A portable image processing unit comprising;
a housing;
a disk drive in said housing;
a removable disk having a high capacity data storage medium for storing digital images, said disk being removably inserted in said disk drive;
at least one socket in said housing for receiving a plug of a removable digital memory for a device of the type used to acquire digital images, said at least one socket connecting said digital images to said disk drive for storage on said disk;
said disk drive having means for connecting read back images stored on said disk to a viewing environment.

2. The image processing unit recited in claim 1, further comprising a main processing board having a microprocessor for controlling said transfer of digital images from said removable digital memory to said disk drive for storage on said disk.

3. The image processing unit recited in claim 1, wherein said device is a digital camera.

4. The image processing unit recited in claim 1, wherein said removable digital memory is a flash card memory.

5. The image processing unit recited in claim 1, wherein said high capacity disk has a storage capacity of about 100 MB.

6. The image processing unit recited in claim 1, wherein said high capacity disk has a storage capacity of about 200 MB.

7. The image processing unit recited in claim 1, wherein said viewing environment comprises a television set.

8. The image processing unit recited in claim 1, wherein said viewing environment comprises a computer.

9. The image processing unit recited in claim 1, wherein said viewing environment comprises a display device having a monitor and wherein said image processing unit is connected directly to said monitor.
